(19) United States
(12) Patent Application Publication
(10) Pub. No.: US 2025/0303627 A1
(43) Pub. Date: Oct. 2, 2025

(54) EXTRUDER BARREL AND METHOD OF REFURBISHMENT

(71) Applicant: Xaloy, LLC, Austintown, OH (US)

(72) Inventors: Cheryl Ann SAYER, Lowell, MA (US); Brad Lee QUEAR, Bessemer, PA (US); Adam Paul SLATER, Orwell, OH (US)

(73) Assignee: Xaloy, LLC, Austintown, OH (US)

(21) Appl. No.: 19/083,524

(22) Filed: Mar. 19, 2025

Related U.S. Application Data
(60) Provisional application No. 63/569,964, filed on Mar. 26, 2024.
(60) Provisional application No. 63/570,542, filed on Mar. 27, 2024.

(51) Int. Cl. B29C 48/68

(52) U.S. Cl. CPC B29C 48/6803

(57) ABSTRACT

An extruder barrel of an extrusion assembly that is separable into at least two portions to completely view a bore defined by the extruder barrel. The extruder barrel includes a first barrel portion that defines a first cavity. The extruder barrel also includes a second barrel portion that removably engages with the first barrel portion and defines a second cavity. The extruder barrel also includes a bore that is collectively defined by the first cavity of the first barrel portion and by the second cavity of the second barrel portion. The extruder barrel also includes a set of connectors that operably engages the first barrel portion and the second barrel portion with one another.

### REFERENCE TO RELATED APPLICATIONS

This application claims the benefit of U.S. Provisional Application Ser. No. 63/569,964, filed on Mar. 26, 2024, and the benefit of U.S. Provisional Application Ser. No. 63/570,542, filed on Mar. 27, 2024; the disclosures of which are incorporated herein by reference.

### TECHNICAL FIELD

This disclosure is directed to a modular extruder barrel usable in an extrusion system.

### BACKGROUND ART

In the extrusion industry, an extrusion system or extruder includes various apparatuses and/or devices are used to manufacture one or more types of objects that have a fixed cross-sectional profile upon being exerted through a shaping die. Particularly, an extrusion system includes an extruder barrel that defines at least one hollow chamber in which one or more extruder screws are housed inside of said hollow chamber. Such interaction between the extruder barrel and extruder screw further melt, convey, and generate pressure on a polymetric material that is fed into the extruder barrel by at least one hopper operable with the extruder barrel. The extrusion operation performed by the extruder barrel must be precise and accurate to produce a uniformly plasticized material of constant composition at a predetermined rate. With such accuracy and precision, the extruder barrel is also placed under high values of operating pressures and operating temperatures in order to produce such uniformly plasticized material of constant composition at a predetermined rate. To combat these needs, a conventional extruder barrel is formed from a unitary, thick walled steel tubing or similar metal material.

However, such construction of a conventional extruder barrel has various drawbacks and detriments. Normally, the hollowed chamber or passageway that is defined in a conventional extruder barrel is machined and ground to a smooth finish, which is a difficult process and is costly given the geometry of the hollowed chamber. Additionally, a conventional extruder barrel also includes a protective layer that is applied to an inner surface or wall that is disposed inside of the hollowed chamber for prevention of corrosion and resistance to wear. However, the unitary structure of the conventional extruder barrel creates extreme difficult to operators when servicing or repairing the barrel due to the limited line of sight or limited clearance inside of the barrel. As such, any repairs or maintenances that must be performed inside of the hollowed chamber, including the protective layer or inner surface, are normally ignored and result in the worn extruder barrel being removed and replaced with a new extruder barrel. Such removal and replacement of these extruder barrels requires extensive labor, loss of operation and profit generated by the extrusion system, and extensive costs relating to the purchasing of a new extruder barrel.

### SUMMARY OF THE INVENTION

In one aspect, an exemplary embodiment of the present disclosure may provide an extruder barrel of an extrusion assembly. The extruder barrel includes a first barrel portion that defines a first cavity. The extruder barrel also includes a second barrel portion that removably engages with the first barrel portion and defines a second cavity. The extruder barrel also includes a bore that is collectively defined by the first cavity of the first barrel portion and by the second cavity of the second barrel portion. The extruder barrel also includes a set of connectors that operably engages the first barrel portion and the second barrel portion with one another.

In another aspect, another exemplary embodiment of the present disclosure may provide an extruder barrel of an extrusion assembly. The extruder barrel includes a first barrel portion that defines a first pair of cavities. The extruder barrel also includes a second barrel portion that removably engages with the first barrel portion and defines a second pair of cavities. The extruder barrel also includes a first bore that is collectively defined by a first cavity of the first pair of cavities and by a first cavity of the second pair of cavities. The extruder barrel also includes a second bore that is collectively defined by a second cavity of the first pair of cavities and by a second cavity of the second pair of cavities. The extruder barrel also includes a set of connectors that operably engages the first barrel portion and the second barrel portion with one another.

In another aspect, another exemplary embodiment of the present disclosure may provide a method of reconditioning an extruder barrel. The method includes steps of loosening a set of connectors of the extruder barrel from a first barrel portion of the extruder barrel and a second barrel portion of the extruder barrel; separating the first barrel portion from the second barrel portion; replacing the first barrel portion with a third barrel portion; aligning the third barrel portion with the second barrel portion by a set of alignment pins of the extruder barrel; and securing the first barrel portion with the second barrel portion by the set of connectors.

This exemplary embodiment may further include that the step of loosening the set of connections further comprises: disengaging the set of connectors from a set of threaded holes defined in the second barrel portion; and removing the set of connectors from a set of passageways defined in the first barrel portion. This exemplary embodiment may further include that the step of separating the first barrel portion from the second barrel portion further comprises: completely viewing a first cavity defined by the first barrel portion and a second cavity of the second barrel portion that collectively define a bore of the extruder barrel. This exemplary embodiment may further include that step of aligning the third barrel portion with the second barrel portion further comprises: engaging the set of alignment pins with the second barrel portion inside a set of first alignment cavities; and passing the set of alignment through the third barrel portion inside a set of second alignment cavities. This exemplary embodiment may further include that the step of separating the first barrel portion from the second barrel portion further comprises: disengaging a first pair of intermediate surfaces of the first barrel portion from a second pair of intermediate surfaces of the second barrel portion. This exemplary embodiment may further include steps of defining a first recess in the first barrel portion that separates the intermediate surfaces of the first pair of intermediate surfaces; and defining a second recess in the second barrel portion that separates the intermediate surfaces of the second pair of intermediate surfaces; wherein the first recess and the second recess are aligned with one another prior to the step of separating the first barrel portion from the second barrel portion. This exemplary embodiment may further include that the step of securing the third barrel portion with the second barrel portion further comprises: engaging a third pair of intermediate surfaces of the third barrel portion with the second pair of intermediate surfaces of the second barrel portion. This exemplary embodiment may further include that the third barrel portion is a refurbished first barrel portion having a reconditioned internal coating.

In yet another aspect, another exemplary embodiment of the present disclosure may provide an extruder barrel of an extrusion assembly. The extruder barrel includes a first barrel portion defining a first cavity. The extruder barrel also includes a second barrel portion that removably engages with the first barrel portion and defines a second cavity. The extruder barrel also includes a bore at least partially defined by the first cavity of the first barrel portion and by the second cavity of the second barrel portion. The first barrel portion and the second barrel portion are also configurable between an assembled configuration and a disassembled configuration.

This exemplary embodiment may further include that when the first barrel portion and the second barrel portion are in the disassembled configuration, line of sights of the first cavity of the first barrel portion and the second cavity of the second barrel portion are completely viewable along longitudinal axes of the first barrel portion and second barrel portion. This exemplary embodiment may further include a set of connectors releasably engaging the first barrel portion and the second barrel portion together at the assembled configuration. This exemplary embodiment may further include that a set of passageways defined in the first barrel portion; and a set of threaded holes defined in the second barrel portion; wherein a respective connector of the set of connectors passes through a respective passageway of the set of passageways and releasably engages with the second barrel portion inside a respective threaded hole of the set of threaded holes. This exemplary embodiment may further include a set of alignment pins that aligns and engages the first barrel portion and the second barrel portion with one another. This exemplary embodiment may further include that a set of first alignment cavities defined in the first barrel portion; and a set of second alignment cavities defined in the second barrel portion; wherein a first end of each alignment pin of the set of alignment pins is received by the first barrel portion inside a respective alignment cavity of the set of first alignment cavities; and wherein a second end of each alignment pin of the set of alignment pins is received by the second barrel portion inside a respective alignment cavity of the set of second alignment cavities. This exemplary embodiment may further include a pair of recesses defined between a first end of the first barrel portion and a second end of the first barrel portion; wherein the pair of recesses are in communication with a set of passageways of the first barrel portion and a set of alignment cavities of the first barrel portion. This exemplary embodiment may further include a first pair of recesses defined between a first end of the first barrel portion and a second end of the first barrel portion; and a second pair of recesses defined between a first end of the second barrel portion and a second end of the second barrel portion; wherein the first pair of recesses are in communication with a first set of passageways of the first barrel portion and a first set of alignment cavities of the first barrel portion; and wherein the second pair of recesses are in communication with a second set of passageways of the second barrel portion and a second set of alignment cavities of the second barrel portion. This exemplary embodiment may further include an internal coating applied to the first cavity of the first barrel portion and the second cavity of the second barrel portion. This exemplary embodiment may further include that when the internal coating is applied to the first cavity of the first barrel portion and the second cavity of the second barrel portion, the extruder barrel is in the disassembled configuration. This exemplary embodiment may further include a third barrel portion defining a third cavity; wherein the bore, collectively, is at least partially defined by the first barrel portion, the second barrel portion, and the third barrel portion. This exemplary embodiment may further include a third barrel portion defining a third cavity; and a fourth barrel portion removably engaging with the third barrel portion and defining a fourth cavity; wherein the bore, collectively, is at least partially defined by the first barrel portion, the second barrel portion, the third barrel portion, and the fourth barrel portion.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a longitudinal sectional view of an extrusion system having an extruder barrel in accordance with one aspect of the present disclosure.

FIG. 2 is a top isometric perspective view of the extruder barrel shown in FIG. 1.

FIG. 3 is an exploded view of the extruder barrel.

FIG. 4 is a partial top perspective of a lower barrel portion of the extruder barrel.

FIG. 5 is a cross-sectional view of the extruder barrel taken through a pair of passageways of a second set of passageways defined in an upper barrel portion of the extruder barrel and lower barrel portion of extruder barrel, wherein upper barrel portion, lower barrel portion, and a set of connectors of the extruder barrel are disassembled from one another.

FIG. 5A is a cross-sectional view of the extruder barrel taken through a pair of passageways of a first set of passageways in upper and lower barrel portions, wherein upper barrel portion, lower barrel portion, and a set of alignment pins of the extruder barrel are disassembled from one another.

FIG. 6 is a similar cross-sectional view shown in FIG. 5, but upper barrel portion, lower barrel portion, and set of connectors of the extruder barrel are assembled with one another.

FIG. 7A is an operational view depicting the removal of a worn barrel portion.

FIG. 7B is another operational view continuing from FIG. 7A, wherein a new or repaired barrel portion is introduced.

FIG. 7C is another operational view continuing from FIG. 7B, wherein the new or repaired barrel portion is assembled with a preexisting barrel portion of the extruder barrel.

FIG. 8 is a method flowchart.

FIG. 9A is an operational view depicting the removal of a first worn barrel portion and a second worn barrel portion.

FIG. 9B is another operational view continuing from FIG. 9A depicting a first refurbished barrel portion and a second refurbished barrel portion.

FIG. 9C is another operational view continuing from FIG. 9B, wherein the first and second refurbished barrel portions are assembled with one another.

FIG. 10A is a top isometric perspective view of an extruder barrel in accordance with a second aspect of the present disclosure.

FIG. 10B is an exploded view of the extruder barrel shown in FIG. 10A

FIG. 11A is a top isometric perspective view of an extruder barrel in accordance with a third aspect of the present disclosure.

FIG. 11B is an exploded view of the extruder barrel shown in FIG. 11A.

FIG. 12 a top isometric perspective view of an extruder barrel in accordance with a fourth aspect of the present disclosure.

FIG. 13 is an exploded view of the extruder barrel shown in FIG. 12.

FIG. 14 is a top isometric perspective view of an extruder barrel in accordance with a fifth aspect of the present disclosure.

FIG. 15 is an exploded view of the extruder barrel shown in FIG. 14.

FIG. 16 is a top isometric perspective view of an extruder barrel in accordance with a sixth aspect of the present disclosure.

FIG. 17 is an exploded view of the extruder barrel shown in FIG. 16.

FIG. 18 is a top isometric perspective view of an extruder barrel in accordance with a seventh aspect of the present disclosure.

FIG. 19 is an exploded view of the extruder barrel shown in FIG. 18.

FIG. 20 is a top isometric perspective view of an extruder barrel in accordance with an eighth aspect of the present disclosure.

Similar numbers refer to similar parts throughout the drawings.

### DETAILED DESCRIPTION

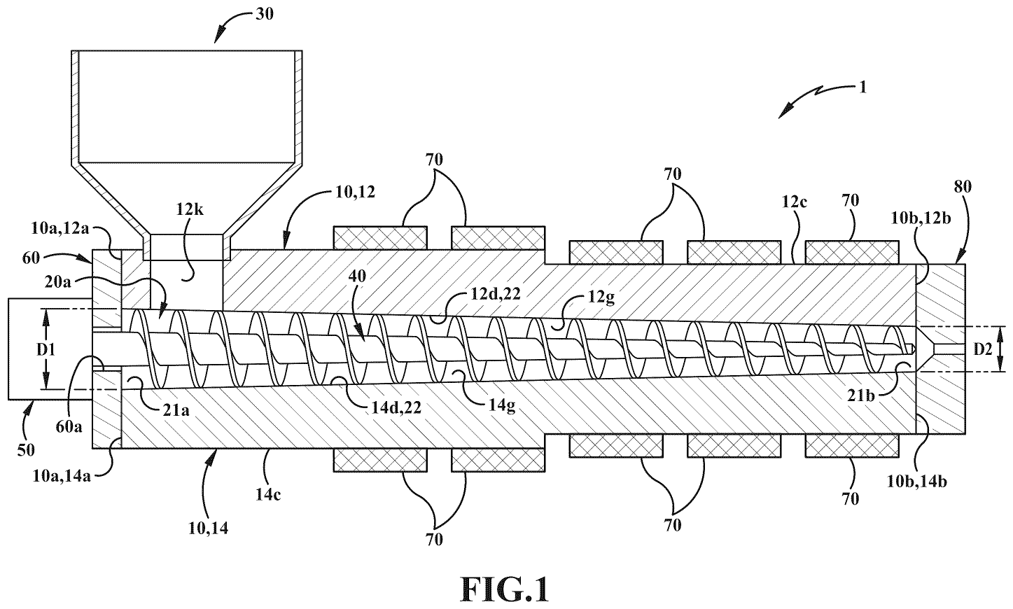

FIG. 1 illustrates an extrusion system generally referred to herein as 1. It should be understood that extrusion system 1 may be configured to extruded and create various types of extruded materials. Such components and/or apparatuses that construct the extrusion system 1 are now discussed in greater detail below.

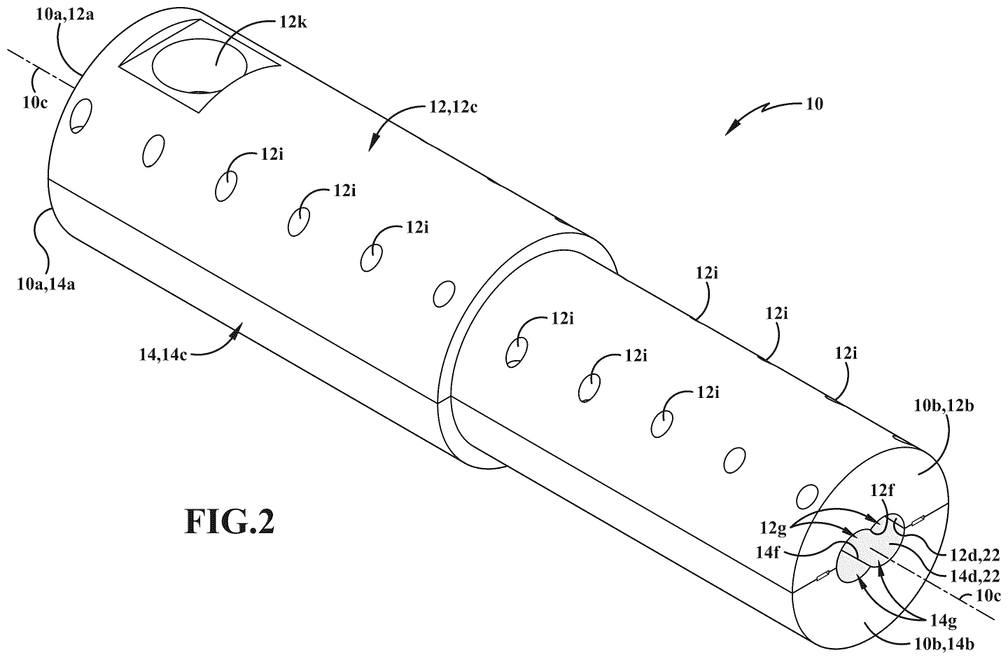

Extrusion system 1 includes an extruder body or extruder barrel 10. As best seen in FIGS. 1-2, extruder barrel 10 includes a first end 10a, a second end 10b that is longitudinally opposite to the first end 10a, and a longitudinal direction extending from the first end 10a to the second end 10b. Extruder barrel 10 also defines at least one bore that extends longitudinally from the first end 10a to the second end 10b that is accessible at each of the first end 10a and the second end 10b; such bore of the extruder barrel 10 is discussed in greater detail below.

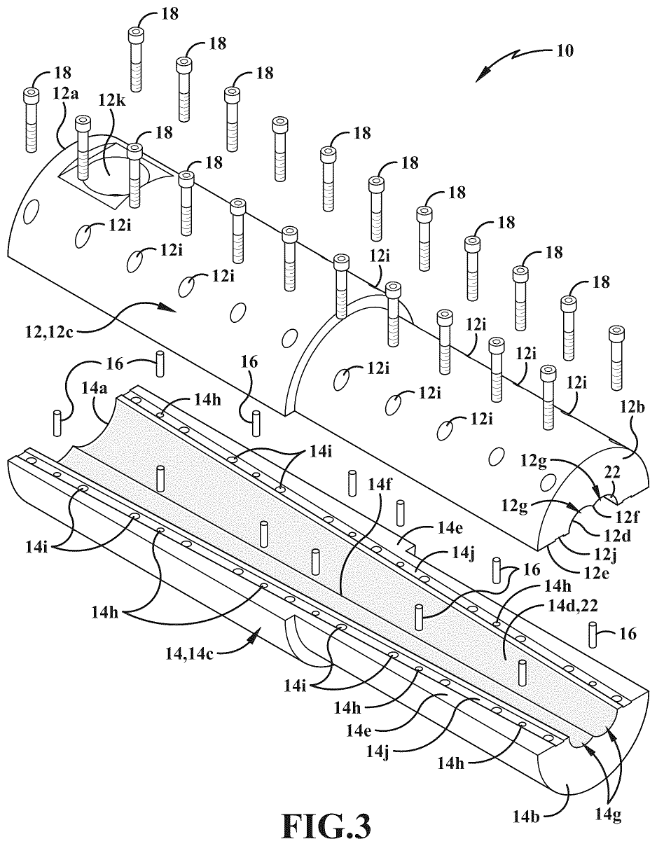

In the present disclosure, the extruder barrel 10 is broken into two main components, a first or upper barrel portion 12 and a second or lower barrel portion 14 (see FIG. 3). As discussed in greater detail below, first barrel portion 12 and second barrel portion 14 are removably engaged with and/or removably attached with one another such that the first barrel portion 12 and the second barrel portion 14 are separable. It should be understood that the structural configuration of first barrel portion 12 and second barrel portion 14 are mirror-images of one another, relative to the longitudinal axis 10c of extruder barrel 10, once the first barrel portion 12 and second barrel portion 14 are assembled with one another.

As best seen in FIG. 3, first barrel portion 12 includes a first end 12a that is positioned at the first end 10a of the extruder barrel 10, a second end 12b that is longitudinally opposite to the first end 12a and is positioned at the second end 10b of the extruder barrel 10, and a longitudinal direction extending from the first end 10a to the second end 10b. Still referring to FIG. 3, first barrel portion 12 also includes an outer surface 12c that extends longitudinally from the first end 12a to the second end 12b along the longitudinal direction of first barrel portion 12. First barrel portion 12 also includes an inner surface 12d that extends longitudinally from the first end 12a to the second end 12b along the longitudinal direction of first barrel portion 12 and is spaced apart from and faces in an opposing direction of the outer surface 12c (see FIG. 3). First barrel portion 12 also includes a pair of intermediate surfaces 12e that extends longitudinally from the first end 12a to the second end 12b along the longitudinal direction of first barrel portion 12. In the present disclosure, each intermediate surface of the pair of intermediate surfaces 12e extends between the outer surface 12c and the inner surface 12d such that each intermediate surface 12e is in communication with the outer surface 12c and the inner surface 12d. Such use and purpose of the pair of intermediate surfaces 12e is discussed in greater detail below.

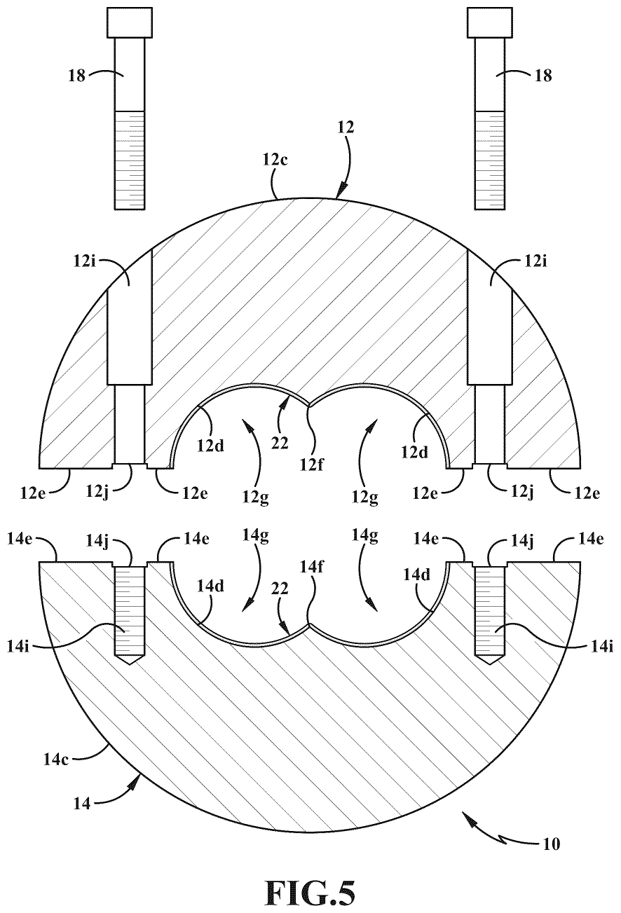

Still referring to first barrel portion 12, first barrel portion 12 also includes an internal ridge 12f. As best seen in FIGS. 3 and 5, the internal ridge 12f extends longitudinally from the first end 12a to the second end 12b along the longitudinal direction of first barrel portion 12. The internal ridge 12f also extends outwardly from the inner surface 12d and interrupts the inner surface 12d to form inner surface 12d into two sections. With such structural configuration, the inner surface 12d and the internal ridge 12f collectively define a pair of cavities 12g inside of the first barrel portion 12. In the present disclosure, each cavity of the pair of cavities 12g extends longitudinally from the first end 12a to the second end 12b along the longitudinal direction of first barrel portion 12. As discussed in greater detail below, the pair of cavities 12g is configured to receive and house a pair of extrusion screws of extrusion system 1 for extrusion operations.

First barrel portion 12 also defines a first set of passageways 12h. As best seen in FIG. 3, each passageway of the first set of passageways 12h extends along an axis that is non-parallel to the longitudinal direction of the first barrel portion 12 (see in dashed). Particularly, each passageway of the first set of passageways 12h extends along an axis from the outer surface 12c to a respective intermediate surface of the pair of intermediate surfaces 12e; the outer surface 12c and the respective intermediate surface of the pair of intermediate surfaces 12e are in communication with one another at each passageway of the first set of passageways 12h. As discussed in greater detail below, each passageway of the first set of passageways 12h is configured to receive and house an alignment pin of a set of alignment pins of the extruder barrel 10 for alignment purposes.

First barrel portion 12 also defines a second set of passageways 12i. Similar to the first set of passageways 12h, and as best seen in FIG. 5, each passageway of the second set of passageways 12i extends along an axis that is non-parallel to the longitudinal direction of the first barrel portion 12. Particularly, each passageway of the second set of passageways 12i extends along an axis from the outer surface 12c to a respective intermediate surface of the pair of intermediate surfaces 12e; the outer surface 12c and the respective intermediate surface of the pair of intermediate surfaces 12e are in communication with one another at each passageway of the second set of passageways 12i. As discussed in greater detail below, each passageway of the first set of passageways 12h is configured to receive and house a connector of a set of connectors of the extruder barrel 10 for attachment purposes.

In the present disclosure, the first set of passageways 12h includes a first row or group of passageways that is defined along a first portion of the first barrel portion 12 and a second row or group of passageways that is defined along a second portion of the first barrel portion 12 transversely opposite to the first row of passageways (see FIG. 5). In the present disclosure, the second set of passageways 12i also includes a first row or group of passageways that is defined along the first portion of the first barrel portion 12 and a second row or group of passageways that is defined along a second portion of the first barrel portion 12 transversely opposite to the first row of passageways (see FIG. 5). It should be noted that any suitable number of rows and/or groups may be defined in the first set of passageways 12h and the second set of passageways 12i.

In the present disclosure, first barrel portion 12 also defines the first set of passageways 12h and the second set of passageways 12i in a predetermined order or pattern. As best seen in FIG. 3, each passageway of the first set of passageways 12h is defined between and/or defined intermediate to two passageways of the second set of passageways 12i. As such, first barrel portion 12 defines a greater number of passageways of the second set of passageways 12i than the number of passageways of the first set of passageways 12i. In other exemplary embodiments, a first barrel portion may defines any suitable number of passageways for a first set of passageways and a second set of passageways.

First barrel portion 12 also defines a pair of recesses 12j. As best seen in FIG. 5, each recess of the pair of recesses 12j is defined between the first end 12a to the second end 12b of the first barrel portion 12. Each recess of the pair of recesses 12j also extends downwardly into a respective intermediate surface of the pair of intermediate surfaces 12e. With such recess 12j defined in each intermediate surface of the pair of intermediate surfaces 12e, each intermediate surface of the pair of intermediate surfaces 12e is bifurcated or split into two sections that are spaced apart from one another. The pair of recesses 12j is also in communication with the first set of passageways 12h and the second set of passageways 12i due to the first set of passageways 12h and the second set of passageways 12i being defined inside of the pair of recesses 12j. Such use of the pair of recesses 12j is considered advantageous because the contact points or surface area along each intermediate surface of the pair of intermediate surfaces 12e is reduced when the first and second barrel portions 12, 14 directly contact one another. With such reduction in surface area along each intermediate surface of the pair of intermediate surfaces 12e, a set of connectors of the extruder barrel 10 may be torqued and/or fastened at a lower torque value while still maintaining an increased sealing pressure on each intermediate surface of the pair of intermediate surfaces 12e remote from the pair of recesses 12j.

First barrel portion 12 also defines a receiving aperture 12k. As best seen in FIGS. 1 and 2, receiving aperture 12k is defined at the first end 12a of the first barrel portion 12. The receiving aperture 12k also extends entirely through the first barrel portion 12 between the outer surface 12c and the inner surface 12d along an axis that is non-parallel to the longitudinal direction of the first barrel portion 12. It should be noted that the outer surface 12c and the inner surface 12d of the first barrel portion 12 is in fluid communication with one another at the receiving aperture 12k. As discussed in greater detail below, the receiving aperture 12k is configured to receive and house a portion of a hopper of the extrusion system 1 so that the extruder barrel 10 and the hopper of the extrusion system 1 are operable with one another.

As discussed previously, second barrel portion 14 of extruder barrel 10 is a mirror-image of the first barrel portion 12 relative to the longitudinal axis 10c of the extruder barrel 10. As such, a first end 14a, a second end 14b, an outer surface 14c, an inner surface 14d, a pair of intermediate surfaces 14e, an internal ridge 14f, a pair of cavities 14g, a first set of passageways 14h, and a pair of recesses 14j are substantially similar to first end 12a, second end 12b, outer surface 12c, inner surface 12d, pair of intermediate surfaces 12e, internal ridge 12f, pair of cavities 12g, first set of passageways 12h, and pair of recesses 12j of first barrel portion 12.

However, with respect to second barrel portion 14, second barrel portion 14 defines a second set of passageways 14i with threads defined inside each passageway of the second set of passageways 14i. In the present disclosure, each passageway of the second set of passageways 14i still extends along an axis that is non-parallel to a longitudinal direction of the second barrel portion 14. Particularly, each passageway of the second set of passageways 14i extends along an axis from the outer surface 14c to a respective intermediate surface of the pair of intermediate surfaces 14e; the outer surface 14c and the respective intermediate surface of the pair of intermediate surfaces 14e are in communication with one another at each passageway of the second set of passageways 14i. As discussed in greater detail below, the second barrel portion 14 is configured to releasably and/or threadably engage with each connector of a set of connectors of the extruder barrel 10 for securing the first barrel portion 12 and the second barrel portion 14 with one another to form the extruder barrel 10.

Extruder barrel 10 also includes a set of alignment pins 16. As best seen in FIG. 3, each alignment pin of the set of alignment pins 16 is receivable by the first set of passageways 12h of first barrel portion 12 and by the first set of passageways 14h of second barrel portion 14 once extruder barrel 10 is assembled. In the present disclosure, each alignment pin of the set of alignment pins 16 is configured to be engaged with the first barrel portion 12 inside each passageway of the first set of passageways 12h or with the second barrel portion 14 inside each passageway of the first set of passageways 14h. In one exemplary embodiment, each alignment pin of the set of alignment pins 16 may be releasably engaged with the first barrel portion 12 inside each passageway of the first set of passageways 12h of first barrel portion 12. In another exemplary embodiment, each alignment pin of the set of alignment pins 16 may be releasably engaged with the second barrel portion 14 inside each passageway of the first set of passageways 14h of second barrel portion 14.

In operation, the set of alignment pins 16 is used to assist operators of such extrusion system 1 in assembling the extruder barrel 10. Prior to assembly extruder barrel 10, each alignment pin of the set of alignment pins 16 is engaged with the second barrel portion 14 inside each passageway of the first set of passageways 14h. Once the set of alignment pins 16 is engaged with the second barrel portion 14, operators may then introduce and align the first barrel portion 12 with the second barrel portion 14 by the set of alignment pins 16. Once aligned, the first barrel portion 12 may be lowered onto the second barrel portion 14 while the set of alignment pins 16 passes through the first set of passageways 12h of the first barrel portion 12 until the pair of intermediate surfaces 12e, 14e of the first and second barrel portions 12, 14 directly contact one another.

Extruder barrel 10 also includes a set of connector 18. As best seen in FIG. 5A, the set of connectors 18 passes through the second set of passageways 12i defined in the first barrel portion 12 and releasably engages with the second barrel portion 14 inside of the second set of passageways 14i. Upon such engagement, the set of connectors 18 releasably secures the first barrel portion 12 and the second barrel portion 14 with one another to form the extruder barrel 10. As discussed previously, the set of connectors 18 releasably engaged with the second barrel portion 14 due to the internal threads defined in the second set of passageways 14i. In other exemplary embodiments, each connector of the set of connectors 18 may engage with a component or element that is separate from the second barrel portion 14. In one example, each connector of the set of connectors 18 may engage with a corresponding nut that is separate from the second barrel portion 14. In this example, second barrel portion 14 would omit any threads inside the second set of passageways 14i. In other exemplary embodiment, other suitable mechanical fastening means or components may be used to engage first and second barrel portions to form an extruder barrel, including banding, welding, and other suitable mechanical fastening means of the like.

As stated previously, the direct contact between the pair of intermediate surfaces 12e, 14e of the first and second barrel portions 12, 14 reduces the torque that is applied to the set of connectors 18 for releasably engaging the first barrel portion 12 and the second barrel portion 14 with one another. With such reduction of torque needed, the sealing torque applied by the set of connectors 18 also increases between the first barrel portion 12 and the second barrel portion 14. By forming the pairs of recesses 12j, 14j in the first and second barrel portions 12, 14, the structural configurations of the pairs of intermediate surfaces 12e, 14e of the first and second barrel portions 12, 14 effectively reduce the square inches of contact between the pair of intermediate surfaces 12e, 14e of the first and second barrel portions 12, 14. With such reduction in contacting space, a lower torque is required on each connector of the set of connectors 18 and the pressure applied on the pair of intermediate surfaces 12e, 14e of the first and second barrel portions 12, 14 is increased.

Extruder barrel 10 also defines a pair of bores 20a, 20b once the first barrel portion 12 and the second barrel portion 14 are releasably engaged with one another. As best seen in FIG. 2, first bore 20a is defined collectively by the first cavity of the pair of cavities 12g of the first barrel portion 12 and the first cavity of the pair of cavities 14g of the second barrel portion 14. Similarly, and as best seen in FIG. 2, second bore 20b is defined collectively by the second cavity of the pair of cavities 12g of the first barrel portion 12 and the second cavity of the pair of cavities 14g of the second barrel portion 14. Upon assembly, the pair of bores 20a, 20b is configured to receive a set of conical extrusion screws of the extrusion system 1 for translating extrusion material inside of the extruder barrel 10.

Extruder barrel 10 also defines a first pair of openings 21a and a second pair of openings 21b that provide accessibility into the pair of bores 20a, 20b. As best seen in FIG. 1, each opening of the first pair of openings 21a is defined at first end 10a of extruder barrel 10 and/or at first ends 12a, 14a of first and second barrel portions 12, 14 when the first and second barrel portions 12, 14 are assembled with one another. Each opening of the first pair of openings 21a defines a first diameter or first width; such first diameter of each opening of the first pair of openings 21a is denoted by a double arrow labeled “D1” in FIG. 1. Each opening of the first pair of openings 21a also provides access the pair of bores 20a, 20b at first end 10a of extruder barrel 10 and/or at first ends 12a, 14a of first and second barrel portions 12, 14 when the first and second barrel portions 12, 14. Similarly, and as best seen in FIG. 1, each opening of the second pair of openings 21b is defined at second end 10b of extruder barrel 10 and/or at second ends 12b, 14b of first and second barrel portions 12, 14 when the first and second barrel portions 12, 14 are assembled with one another. Each opening of the second pair of openings 21b defines a second diameter or second width; such second diameter of each opening of the second pair of openings 21b is denoted by a double arrow labeled “D2” in FIG. 1. Each opening of the second pair of openings 21b also provides access the pair of bores 20a, 20b at second end 10b of extruder barrel 10 and/or at second ends 12b, 14b of first and second barrel portions 12, 14 when the first and second barrel portions 12, 14.

In the present disclosure, the first diameter D1 of each opening of the first pair of openings 21a is greater than the second diameter D2 of each opening of the second pair of openings 21b. Such difference in diameters between the first pair of openings 21a and the second pair of openings 21b creates a conical shape along the bores 20a, 20b when viewing extruder barrel 10 from a longitudinal section view (see FIG. 1) or when viewing a barrel portion from a top perspective view (see second barrel portion 14 in FIG. 3). Such conical shape enables a conical twin extrusion screw assembly of extrusion system 1 to be fitted with and housed inside of extruder barrel 10 for extrusion operations. In other exemplary embodiments, the first diameter D1 of each opening of the first pair of openings 21a and the second diameter D2 of each opening of the second pair of openings 21b may be any suitable size or shape relative to one another. In one example, the first diameter D1 of each opening of the first pair of openings 21a and the second diameter D2 of each opening of the second pair of openings 21b may be equal to one another. In this example, such equal diameters between the first pair of openings 21a and the second pair of openings 21b creates a uniform or parallel shape along the bores 20a, 20b when viewing extruder barrel 10 from a longitudinal section view or when viewing a barrel portion from a top perspective view; as such, a parallel twin extrusion screw assembly of extrusion system 1 may be fitted with and housed inside of extruder barrel for extrusion operations.

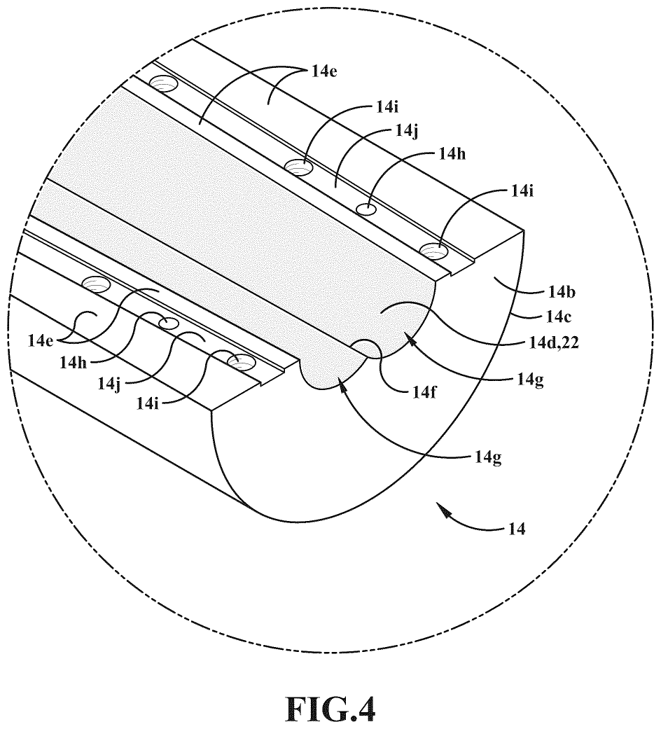

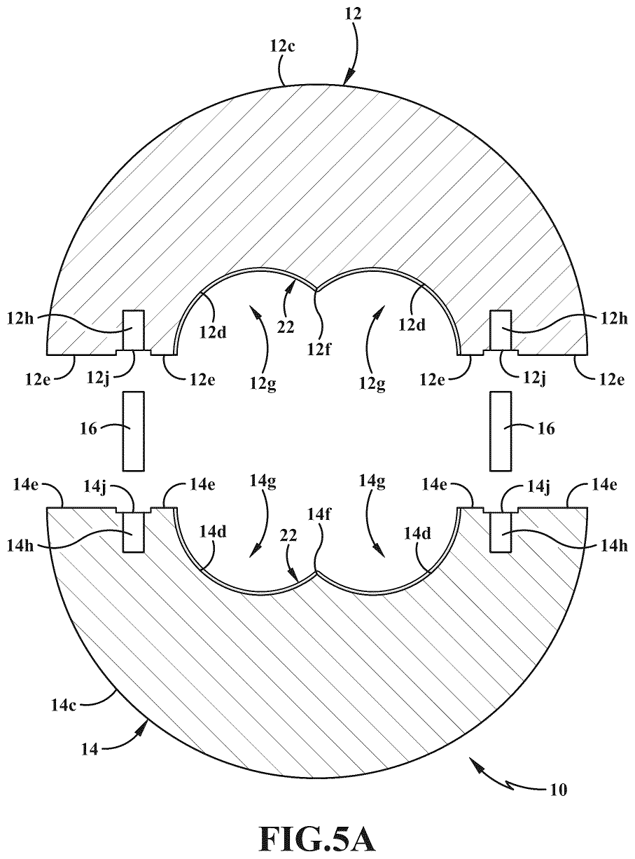

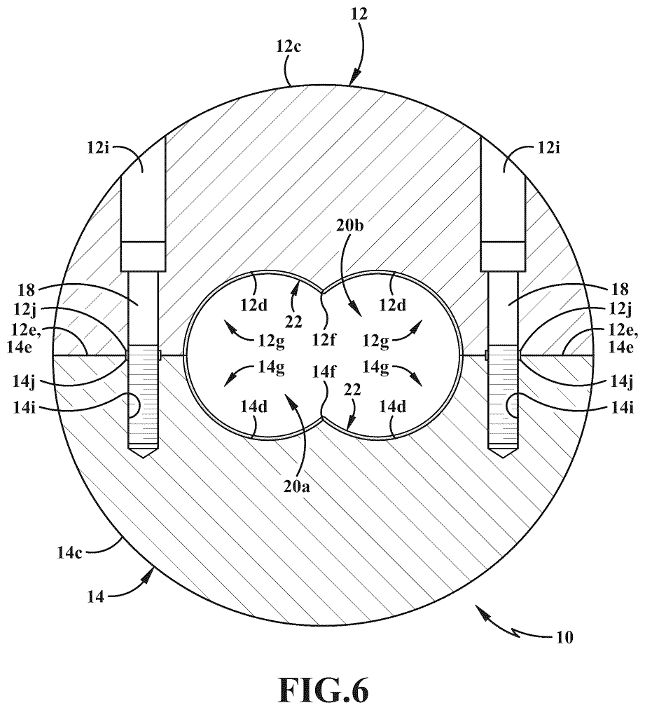

Extruder barrel 10 also includes an internal coating 22. In the present disclosure, internal coating 22 is applied along the inner surface 12d and the internal ridge 12f of the first barrel portion 12 inside of the pair of cavities 12g; such internal coating 22 formed inside of the first barrel portion 12 is denoted by a grey-tone shown in FIGS. 5-6. Similarly, internal coating 22 is also formed along the inner surface 14d and the internal ridge 14f of the second barrel portion 14 inside of the pair of cavities 14g; such internal coating 22 formed inside of the second barrel portion 14 is denoted by a grey-tone hatching shown in FIGS. 3-6.

It should be understood that internal coating 22 applied to the extruder barrel 10, particularly the pairs of inner surfaces 12d, 14d and internal ridges 12f, 14f of the first and second barrel portions 12, 14, may be any suitable corrosion protection and/or wear resistant inlay or coating. Examples of suitable internal coatings that may be applied to internal walls and/or surfaces of extruder barrel include, but are not limited to, powder form coating, wire form coating, spray coating with electrical discharge machining (EDM) curing, laser cladding, tungsten carbide, diamond, high velocity oxygen fuel (HVOF) tungsten carbide coating, high velocity air-fuel (HVAF) tungsten carbide coating, HVOF diamond coating, plasma inconel, ceramic coatings, high nickel alloys, chromium and other suitable coatings that may be applied to internal walls and/or surfaces of extruder barrel to provide corrosion protection, wear resistance, lubrication, and combinations of the like.

The structural configuration of extruder barrel 10 is considered advantageous at least because operators and users of extruder barrel 10 are able to recondition, repair, and/or rebuild the existing extruder barrel 10 without completely disposing of the extruder barrel 10. As discussed above, first and second barrel portions 12, 14 are releasably engaged with one another thus allowing operators and users to separate such first and second barrel portions 12, 14 from one another for repair and reconditioning reasons. As such, when the first barrel portion 12 or second barrel portion 14 is worn or damaged due to corrosion or wear, operators of extruder barrel 10 may simply remove the worn barrel portion to which the worn barrel portion may be repaired or may be replaced by new barrel portion. Such modulatory of extruder barrel 10 will reduce the overall reconditioning and repair costs for users of these extruder barrels as well as reduction in labor time and operation time when such extruder barrel 10 needs to be reconditioned.

Furthermore, the structural configuration of extruder barrel 10 is also considered advantageous at least because operators of these extruder barrels 10 will have a greater line of sight or clearance when needing to view or inspect the interior space of extruder barrel 10, including inner surfaces 12d, 14d or internal coating 22. With such greater line of sight, the application of the internal coating 22 is also easier and quicker due to the inner surfaces 12d, 14d being easily accessible when the extruder barrel 10 is broken down and the first and second barrel portions 12, 14 are separated from one another.

As discussed above, the line of sight along the inner surfaces 12d, 14d of the first and second barrel portions 12, 14 allows for the operation of applying and/or adding a laser cladding (i.e., internal coating 22) as compared to conventional extruder barrels preventing such application. In one example, operators of extruder barrel 10 may apply laser cladding along the entire length of the inner surfaces 12d, 14d of new first and second barrel portions 12, 14 when said first and second barrel portions 12, 14 are separated from one another and the inner surfaces 12d, 14d are completely viewable. With such separability of the first and second barrel portions 12, 14, the line of sight along the inner surfaces 12d, 14d of said first and second barrel portions 12, 14 is no longer impeded from precisely and accurately applying an initial application of laser cladding (and other similar inlays or coatings mentioned herein). In another example, operators of extruder barrel 10 may apply laser cladding along the entire length of the inner surfaces 12d, 14d of worn first and second barrel portions 12, 14 when the worn first and second barrel portions 12, 14 are separated from one another and the inner surfaces 12d, 14d are completely viewable. With such separability and full line of sight, worn barrel portions 12, 14 may be refurbished, reconditioned, and/or repaired where a new application of laser cladding (and other similar inlays or coatings mentioned herein) may be applied. With such operations of refurbishment, owners of these extruder barrel 10 may be free from discarding and/or disposing of a worn extruder barrel 10 as compared to common practices and procedures of conventional extruder barrels.

Extrusion system 1 also includes hopper 30 that operably engages with the extruder barrel 10. As best seen in FIG. 1, hopper 30 operably engages with the extruder barrel 10 and is in fluid communication with the pair of bores 20a, 20b of the extruder barrel 10. More particularly, hopper 30 operably engages with first barrel portion 12 of the extruder barrel 10 at the receiving aperture 12k and is in fluid communication with the pair of bores 20a, 20b of the extruder barrel 10 via the receiving aperture 12k. While not illustrated herein, hopper 30 is configured to feed a predetermined amount of extrusion material (e.g., polymetric pellets and other forms of the like) into the extruder barrel 10 for extrusion operations. It should be understood that hopper 30 may be any conventional and/or commercially-available hopper or similar feeding apparatus that is or is not available as of the filing date of this disclosure.

Extrusion system 1 also includes twin conically-shaped extrusion screws 40 that are received and housed inside of the extruder barrel 10. As best seen in FIG. 1, a first extrusion screw of the twin extrusion screws 40 is housed inside of first bore 20a of extrusion system 1 for directing molten material from the first end 10a of extruder barrel 10 to the second end 10b of extruder barrel for extrusion processes. While not illustrated herein, a second extrusion screw of the twin extrusion screws 40 is housed inside of second bore 20b of extrusion system 1 for directing molten material from the first end 10a of extruder barrel 10 to the second end 10b of extruder barrel for extrusion processes. Each extrusion screw of the twin extrusion screws 40 may also be powered by at least one drive system 50 that rotates the twin extrusion screws 40 at desired revolutions inside of the extruder barrel 10 during extrusion process.

In other exemplary embodiments, extrusion system 1 may include any suitable extrusion screw that is operable with the extruder barrel 10 as dictated by the size, shape, and structural configuration of extruder barrel 10. In one example, a single extrusion screw may be operable with an extruder barrel when said extruder barrel defines a single bore. In another example, a twin parallel-shaped extrusion screw may be operable with an extruder barrel when said extruder barrel defines a pair of bores that are parallel to one another.

Extrusion system 1 also includes an end cap 60 that operably engages with extruder barrel 10. As best seen in FIG. 1, end cap 60 operably engages with the extruder barrel 10 at the first end 10a to cover the pair of bores 20a, 20b. Such covering performed by end cap 60 may simply prevent material from exiting the extruder barrel 10 at the first end 10a, prevent external elements surrounding the extrusion system 1 from entering into the extruder barrel 10, and other various reasons of the like. It should be noted that end cap 60 may define a through-hole or hole 60a so that drive shaft of the twin extrusion screws 40 may be operable with drive system 50.

Extrusion system 1 also includes a set of heaters 70 that operably engage with the extruder barrel 10. As best seen in FIG. 1, the set of heaters 70 is positioned circumferentially about extruder barrel 10 between the hopper 30 and the second end 10b of the extruder barrel 10. In operation, each heater of the set of heaters 70 generates a predetermined amount of thermal heat that permeates from the outer surfaces 12c, 14c of the first and second barrel portions 12, 14 to the inner surfaces 12d, 14d of the first and second barrel portions 12, 14 for melting pellets and other extruded material from a solid state to a liquid state. It should be understood that each heater of the set of heaters 70 may be any conventional and/or commercially-available heater that is or is not available as of the filing date of this disclosure.

Extrusion system 1 also includes a shaping die 80 that is operable with the extruder barrel 10. As best seen in FIG. 1, shaping die 80 operably engages with the second end 10b of extruder barrel 10 and is in fluid communication with the pair of bores 20a, 20b. In operation, shaping die 80 defines a structural configuration to shape and/or mold molten material into a desired fixed, cross-sectional shape based the application of extrusion system 1. It should be understood that shaping die 80 may be any conventional and/or commercially-available die that is or is not available as of the filing date of this disclosure.

Having now discussed the components of extrusion system 1, including extruder barrel 10, as well as assembling extruder barrel 10, a method of reconditioning extruder barrel 10 is discussed in greater detail below.

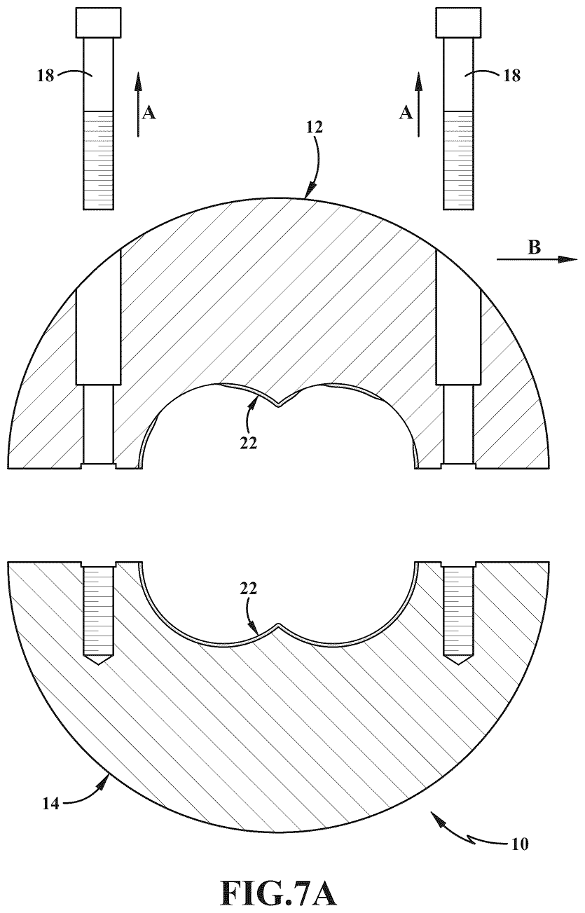

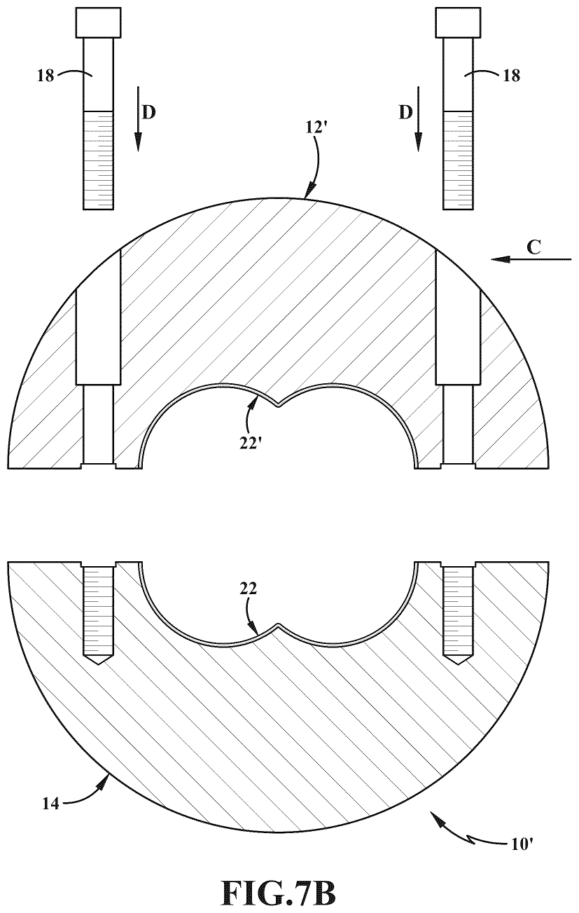

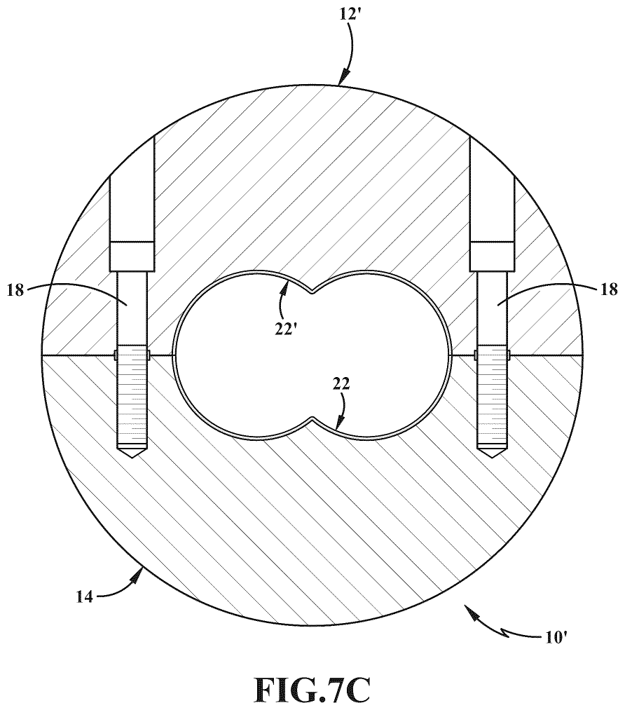

Prior to removing a worn or damaged barrel portion (e.g., first barrel portion 12 or second barrel portion 14), operators of extrusion system 1 must first loosen and remove the set of connectors 18 from the first barrel portion 12 and the second barrel portion 14; such loosening and removal of the set of connectors 18 is denoted by arrows labeled “A” in FIG. 7A. Such means of loosening and removing the set of connectors from the first barrel portion 12 and the second barrel portion 14 may be performed by using an external tool or external power tool. Once the set of connectors 18 is removed, operators may then separate the first barrel portion 12 and the second barrel portion 14 from one another. In this particular example, the first barrel portion 12 is depicted as the worn or damaged barrel portion that will be either repaired or replaced by a new or third barrel portion, which is discussed in greater detail below. In this example, the first barrel portion 12 is depicted as being removed from the second barrel portion 14 for reconditioning needs; such removal of first barrel portion 12 is denoted by an arrow labeled “B” in FIG. 7A.

Once the first barrel portion 12 is removed, operators may then introduce a rebuilt first barrel portion or a third, new barrel portion to second barrel portion 14; such barrel portion is generally labeled as 12′ in FIG. 7B and such introduction of third barrel portion 12′ is denoted by an arrow labeled “C” in FIG. 7B. Once third barrel portion 12′ is introduced, operators may then align the third barrel portion 12′ with the second barrel portion 14 based on the set of alignment pins 16. At this stage, the set of alignment pins 16 passes into the first set of passageways 12h′ and is housed inside of the third barrel portion 12′ as the third barrel portion 12′ is lowered onto the second barrel portion 14. Such lowering of the third barrel portion 12′ onto the second barrel portion 14 continues until the pair of intermediate surfaces 12e′ of the third barrel portion 12′ directly contacts the pair of intermediate surfaces 14e of the second barrel portion 14 (see FIG. 7C).

Once the second barrel portion 14 and the third barrel portion 12′ directly contact with one another, operators may then reintroduce the set of connectors 18; such reintroduction of the set of connectors 18 is denoted by arrows labeled “D” in FIG. 7B. As described previously, the set of connectors 18 passes through the third barrel portion 12′ at the second set of passageways 12i′ and releasably engages with the second set of passageways 14i of second barrel portion 14. It should be noted that due to the set of recesses 12k′ 14n defined in the second barrel portion 14 and the third barrel portion 12′, the torque needed to create a suitable sealed pressure between the second barrel portion 14 and the third barrel portion 12′ is reduced. As such, the time and labor needed to engage the set of connectors 18 with the second barrel portion 14 and the third barrel portion 12′ is reduced. Once the set of connectors 18 are engaged with the second barrel portion 14, reconditioned extruder barrel 10′ is then ready to be assembled with the remaining apparatuses of the extrusion system 1 mentioned herein.

It should be noted that while first barrel portion 12 was removed and replaced with a rebuilt first barrel portion or new, third barrel portion, such reconditioning processes and methods may be used on the second barrel portion 14 when such second barrel portion 14 is worn or damaged. As such, second barrel portion 14 would be removed and replaced with a rebuilt second barrel portion or new, fourth barrel portion.

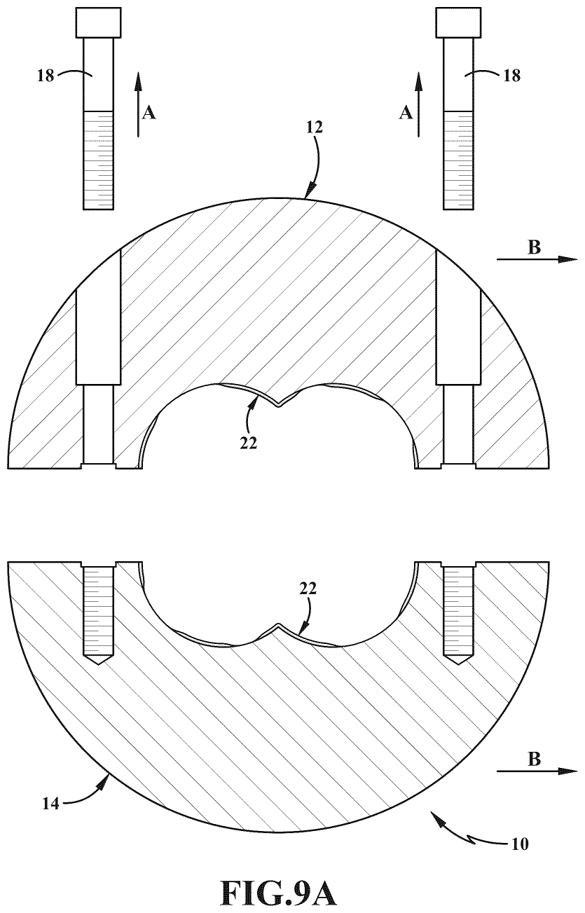

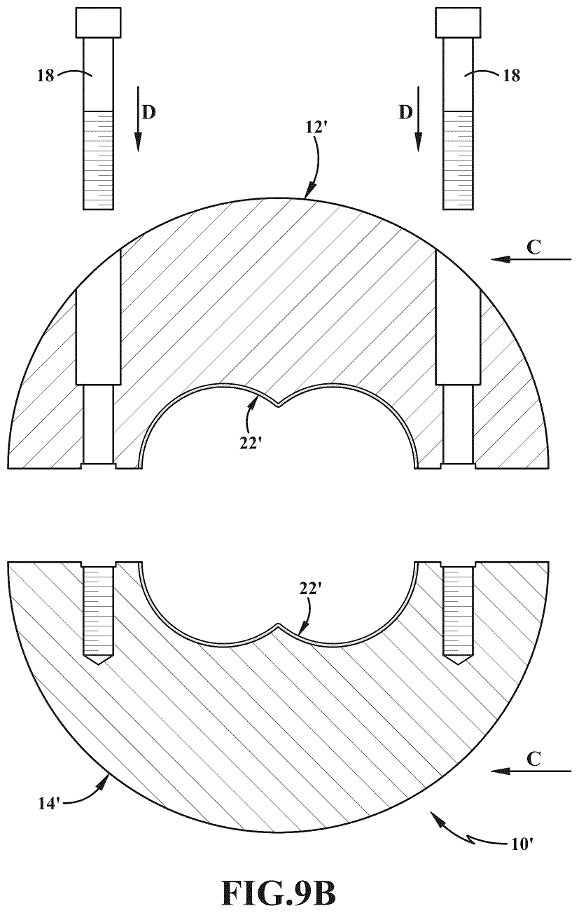

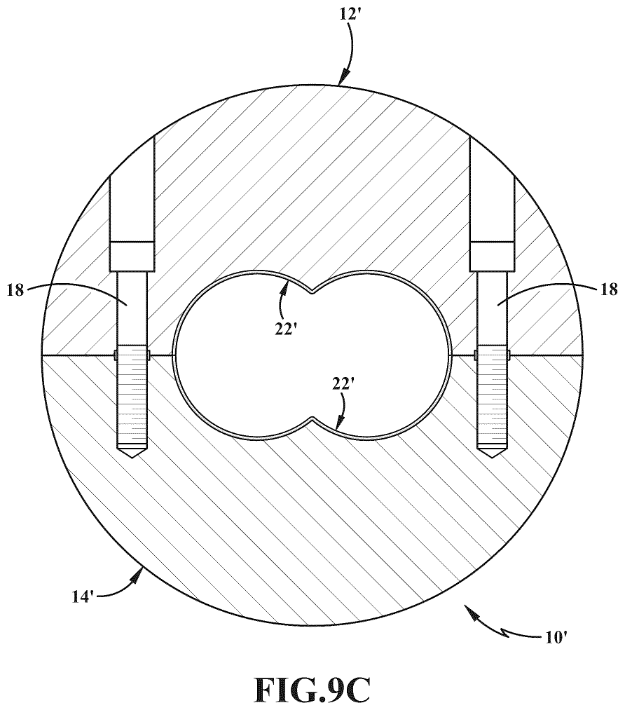

FIGS. 9A-9C illustrate another method of reconditioning extruder barrel 10, particularly both first and second barrel portions 12, 14 simultaneously. In this embodiment, the internal coatings 22 of first and second barrel portions 12, 14 are both worn and/or damaged in a similar pattern due to various reasons, including interaction with extrusion screws 40, materials corroding and/or removing internal coating inside of the extruder barrel 10, and other similar reasons of the like.

Prior to removing worn and/or damaged barrel portions (e.g., first barrel portion 12 and second barrel portion 14), operators of extrusion system 1 must first loosen and remove the set of connectors 18 from the first barrel portion 12 and the second barrel portion 14; such loosening and removal of the set of connectors 18 is denoted by arrows labeled “A” in FIG. 9A. Such means of loosening and removing the set of connectors from the first barrel portion 12 and the second barrel portion 14 may be performed by using an external tool or external power tool. Once the set of connectors 18 is removed, operators may then separate the first barrel portion 12 and the second barrel portion 14 from one another. In this particular example, the first barrel portion 12 and the second barrel portion 14 are each depicted a worn and/or damaged internal coating 22 that will be either reconditioned or refurbished with new internal coatings or replaced by new barrel portions, which are discussed in greater detail below. In this example, the first barrel portion 12 and second barrel portion 14 are each depicted as being removed for reconditioning needs; such removal of first and second barrel portions 12, 14 is denoted by arrows labeled “B” in FIG. 9A.

Once the first barrel portion 12 and the second barrel portion 14 are each removed, operators may then perform operations of refurbishing and/or reconditioning each of the first barrel portion 12 and the second barrel portion 14. As discussed previously, operators may apply a new internal coating or inlay 22′ to each of the first barrel portion 12 and the second barrel portion 14 until the inner surfaces 12d, 14d are protected by an new internal coating or inlay. It should be understood that any suitable techniques and/or methods of applying a new internal coating or inlay 22′ to each barrel portion 12, 14 may be used. As discussed previously, the separation of the barrel portions 12, 14 provides a complete line of sight along the entire length of the barrel portions 12, 14 which allows for a precise and accurate application of a new internal coating.

Once the new internal coatings 22′ are applied, operators may then introduce refurbished or third and fourth barrel portions 12′, 14′ to assemble a refurbished extruder barrel 10′; such introduction of third and fourth barrel portions 12′, 14′ is denoted by arrows labeled “C” in FIG. 9B. If, however, such refurbishment of one or both of the worn first barrel portion 12 and the second barrel portion 14 is not possible, operators may then introduce one or more new barrel portions 12′, 14′ to assemble a refurbished extruder barrel 10′. Once refurbished barrel portions 12′, 14′ are introduced, operators may then align the first refurbished barrel portion 12′ with the second refurbished barrel portion 14′ based on the set of alignment pins 16. It should be noted that prior to such alignment, operators operably engage the set of alignment pins 16 with the second refurbished barrel portion 14′. Once aligned, the set of alignment pins 16 passes into the first set of passageways 12h′ and is housed inside of the first refurbished barrel portion 12′ as the first refurbished barrel portion 12′ is lowered onto the second refurbished barrel portion 14′. Such lowering of the first refurbished barrel portion 12′ onto the second refurbished barrel portion 14′ continues until the pair of intermediate surfaces 12e′ of the first refurbished barrel portion 12′ directly contacts the pair of intermediate surfaces 14e′ of the second refurbished barrel portion 14′ (see FIG. 9C).

Once the first refurbished barrel portion 12′ and the second refurbished barrel portion 14′ directly contact with one another, operators may then reintroduce the set of connectors 18; such reintroduction of the set of connectors 18 is denoted by arrows labeled “D” in FIG. 9B. As described previously, the set of connectors 18 passes through the first refurbished barrel portion 12′ at the second set of passageways 12i′ and releasably engages with the second set of passageways 14i′ of second refurbished barrel portion 14′. It should be noted that due to the set of recesses 12k′, 14n′ defined in the first refurbished barrel portion 12′ and the second refurbished barrel portion 14′, the torque needed to create a suitable sealed pressure between the first refurbished barrel portion 12′ and the second refurbished barrel portion 14′ is reduced. As such, the time and labor needed to engage the set of connectors 18 with the first refurbished barrel portion 12′ and the second refurbished barrel portion 14′ is reduced. Once the set of connectors 18 are engaged with the second refurbished barrel portion 14′, reconditioned extruder barrel 10′ is then ready to be assembled with the remaining apparatuses of the extrusion system 1 mentioned herein.

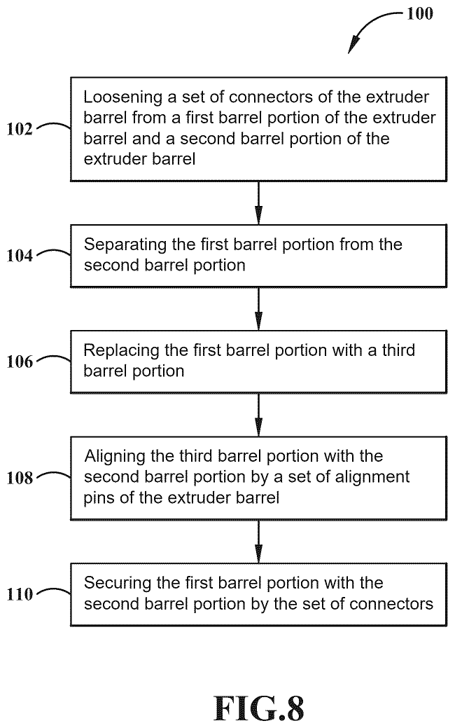

FIG. 8 illustrates a method 100 of reconditioning an extruder barrel. An initial step 102 of method 100 includes loosening a set of connectors of the extruder barrel from a first barrel portion of the extruder barrel and a second barrel portion of the extruder barrel. Another step 104 of method 100 includes separating the first barrel portion from the second barrel portion. Another step 106 of method 100 includes replacing the first barrel portion with a third barrel portion. Another step 108 of method 100 includes aligning the third barrel portion with the second barrel portion by a set of alignment pins of the extruder barrel. Another step 110 of method 100 includes securing the first barrel portion with the second barrel portion by the set of connectors.

In other exemplary embodiments, method 100 may further includes steps of reconditioning an extruder barrel. In one exemplary embodiment, method 100 may further include that the step of loosening the set of connections further comprises: disengaging the set of connectors from a set of threaded holes defined in the second barrel portion; and removing the set of connectors from a set of passageways defined in the first barrel portion. In another exemplary embodiment, method 100 may further include that the step of separating the first barrel portion from the second barrel portion further comprises: completely viewing a first cavity defined by the first barrel portion and a second cavity of the second barrel portion that collectively define a bore of the extruder barrel. In another exemplary embodiment, method 100 may further include that step of aligning the third barrel portion with the second barrel portion further comprises: engaging the set of alignment pins with the second barrel portion inside a set of first alignment cavities; and passing the set of alignment through the third barrel portion inside a set of second alignment cavities. In another exemplary embodiment, method 100 may further include that the step of separating the first barrel portion from the second barrel portion further comprises: disengaging a first pair of intermediate surfaces of the first barrel portion from a second pair of intermediate surfaces of the second barrel portion. In another exemplary embodiment, method 100 may further include steps of defining a first recess in the first barrel portion that separates the intermediate surfaces of the first pair of intermediate surfaces; and defining a second recess in the second barrel portion that separates the intermediate surfaces of the second pair of intermediate surfaces; wherein the first recess and the second recess are aligned with one another prior to the step of separating the first barrel portion from the second barrel portion. In another exemplary embodiment, method 100 may further include that the step of securing the third barrel portion with the second barrel portion further comprises: engaging a third pair of intermediate surfaces of the third barrel portion with the second pair of intermediate surfaces of the second barrel portion. In another exemplary embodiment, method 100 may further include that the third barrel portion is a refurbished first barrel portion having a reconditioned internal coating.

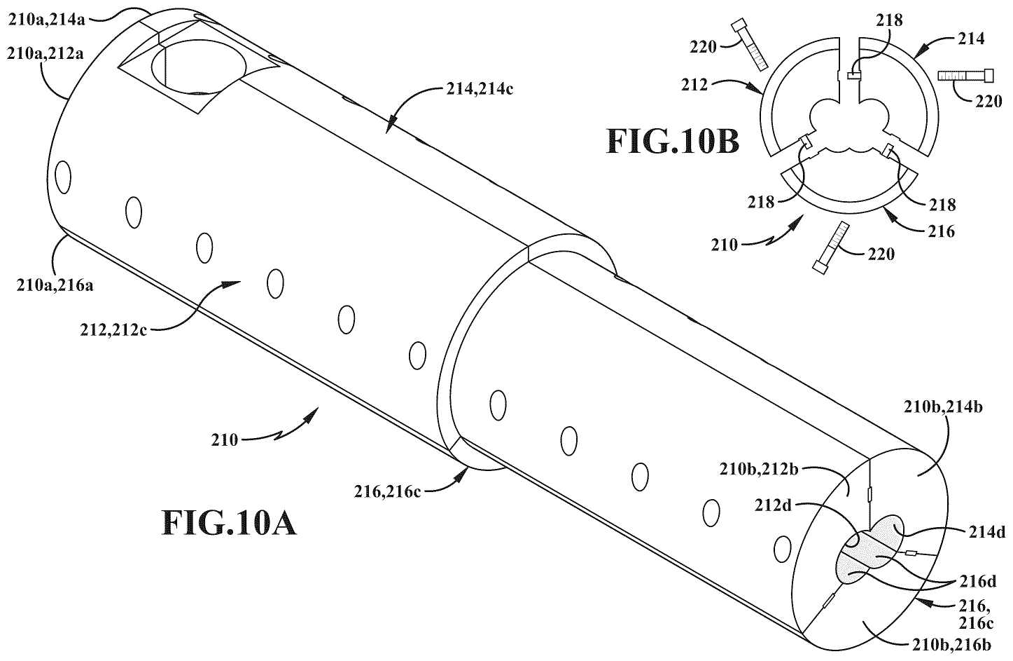

FIGS. 10A-10B illustrate another or second extruder barrel or extruder body 210. In this embodiment, extruder barrel 210 includes a first end 210a, a second end 210b that is longitudinally opposite to the first end 210a, and a longitudinal direction extending from the first end 210a to the second end 210b. Extruder barrel 210 also defines a pair of main bores along a longitudinal axis of extruder barrel 210 that extends longitudinally from the first end 210a to the second end 210b and is accessible at each of the first end 210a and the second end 210b; such pair of bores of the extruder barrel 210 is discussed in greater detail below.

In the present disclosure, the extruder barrel 210 is broken into three main components, a first barrel portion 212, a second barrel portion 214, and a third barrel portion 216 (see FIG. 10B). As discussed in greater detail below, first barrel portion 212, second barrel portion 214, and third barrel portion 216 are removably engaged and/or removably attached with one another such that the first barrel portion 212, the second barrel portion 214, and the third barrel portion 216 are separable. It should be understood that the structural configuration of first barrel portion 212, second barrel portion 214, and third barrel portion 216 are substantially similar to one another and collectively define the pair of bores for extruder barrel 210.

As best seen in FIG. 10A, first barrel portion 212 includes a first end 212a that is positioned at the first end 210a of the extruder barrel 210, a second end 212b that is longitudinally opposite to the first end 212a and is positioned at second end 210b of the extruder barrel 210, and a longitudinal direction extending from the first end 212a to the second end 212b. Still referring to FIG. 10A, first barrel portion 212 also includes an outer surface 212c that extends longitudinally from the first end 212a to the second end 212b along the longitudinal direction of first barrel portion 212. First barrel portion 212 also defines at least one bore 212d. As best seen in FIG. 10A, the bore 212d is defined collectively by an inner or interior surface (such as inner surface 12d of first barrel portion 12 discussed above) that extends longitudinally from the first end 212a to the second end 212b along the longitudinal direction of first barrel portion 212. Upon assembly, the bore 212d is configured to receive a set of conical extrusion screws of an extrusion system (such as extrusion system 1) for translating extrusion material inside of the extruder barrel 210.

Still referring to FIG. 10A, second barrel portion 214 includes a first end 214a that is positioned at first end 210a of the extruder barrel 210, a second end 214b that is longitudinally opposite to the first end 214a and is positioned at the second end 210b of the extruder barrel 210, and a longitudinal direction extending from the first end 214a to the second end 214b. Still referring to FIG. 10A, second barrel portion 214 also includes an outer surface 214c that extends longitudinally from the first end 214a to the second end 214b along the longitudinal direction of second barrel portion 214. Second barrel portion 214 also defines at least one bore 214d. As best seen in FIG. 10A, bores 214d is defined collectively by an inner or interior surface (such as inner surface 14d of second barrel portion 14 discussed above) that extends longitudinally from the first end 214a to the second end 214b along the longitudinal direction of second barrel portion 214. Upon assembly, bore 214d is also configured to receive a set of conical extrusion screws of an extrusion system (such as extrusion system 1) for translating extrusion material inside of the extruder barrel 210.

Still referring to FIG. 10A, third barrel portion 216 includes a first end 216a that is positioned at first end 210a of the extruder barrel 210, a second end 216b that is longitudinally opposite to the first end 216a and is positioned at the second end 210b of the extruder barrel 210, and a longitudinal direction extending from the first end 216a to the second end 216b. Still referring to FIG. 10A, third barrel portion 216 also includes an outer surface 216c that extends longitudinally from the first end 216a to the second end 216b along the longitudinal direction of third barrel portion 216. Third barrel portion 216 also defines at least one bore 216d. As best seen in FIG. 10A, bores 216d is defined collectively by an inner or interior surface (such as inner surfaces 12d, 14d of first and second barrel portions 12,14 discussed above) that extends longitudinally from the first end 216a to the second end 216b along the longitudinal direction of third barrel portion 216. Upon assembly, bore 214d is also configured to receive a set of conical extrusion screws of an extrusion system (such as extrusion system 1) for translating extrusion material inside of the extruder barrel 210.

It should be understood that the bore 212d of first barrel portion 212, bore 214d of second barrel portion 214, and bore 216d of third barrel portion 216 collectively define a main pair of bores for extruder barrel 210 that extends longitudinally between the first and second ends 210a, 210b of extruder barrel 210 substantially similarly to the pair of bores 20a, 20b of the extruder barrel 10 discussed above.

Extruder barrel 210 also includes a set of alignment pins or dowels 218 to align the first barrel portion 212, the second barrel portion 214, and the third barrel portion 216 with one another for ease of assembly. Prior to assembly, the set of alignment pins 218 may be engaged and/or seated with the first, second, and third barrel portions 212, 214, 216 inside a respective alignment cavity or hole similar to the engagement of the set of alignment pins 16 with extruder barrel 10. During assembly, the set of alignment pins 218 may then be introduced and aligned with receiving alignment cavities or holes defined in the receiving barrel portion. For example, and as best seen in FIG. 10B, the set of alignment pins 218 preinstalled in the first barrel portion 212 is to be received by receiving alignment cavities or holes defined in the third barrel portion 216. Once aligned, receiving barrel portion (such as third barrel portion 216 in the example above) may be moved onto the first barrel portion 212 while the set of alignment pins 218 are housed inside of receiving alignment cavities or holes defined of the receiving barrel portion until the two barrel portions directly contact one another.

Extruder barrel 210 also includes a set of connectors 220 that removably engage first, second, and third barrel portions 212, 214, 216 with one another. Particularly, and as best seen in FIG. 101B, the set of connectors 220 removably engages first, second, and third barrel portions 212, 214, 216 with one another. In this embodiment, the set of connectors 220 pass through a set of openings defined in one barrel portion (such as first barrel portion 212) and threadedly engage with a set of threaded cavities defined in another barrel portion (such as third barrel portion 216) to engage both barrel portions with one another.

In other exemplary embodiments, other mechanical configurations may be used to removably engage first, second, and third barrel portions 212, 214, 216 with or without the set of connectors 220. In one exemplary embodiment, a separate attachment component may be used to removably engage first, second, and third barrel portions 212, 214, 216 with one another.

Similar to extruder barrel 10 discussed above, it should be understood that bores 212d, 214d, 216d of extruder barrel 210 includes an internal coating. In the present disclosure, internal coating is applied along the inner surfaces of first, second, and third barrel portions 212, 214, 216 inside of bores 212d, 214d, 216d; such internal coating formed inside of first, second, and third barrel portions 212, 214, 216 is denoted by a grey-tone shown in FIG. 10A. It should be understood that internal coating applied to the extruder barrel 210 may be any suitable corrosion protection and/or wear resistant inlay or coating as discussed herein.

The structural configuration of extruder barrel 210 is considered advantageous at least because operators and users of extruder barrel 210 are able to recondition, repair, and/or rebuild the existing extruder barrel 210 without completely disposing of the extruder barrel 210. As discussed above, first, second, and third barrel portions 212, 214, 216 are releasably engaged with one another thus allowing operators and users to separate such first, second, and third barrel portions 212, 214, 216 from one another for repair and reconditioning reasons. As such, when one of the first, second, and third barrel portions 212, 214, 216 is worn or damaged due to corrosion or wear, operators of extruder barrel 210 may simply remove the worn barrel portion to which the worn barrel portion may be repaired or may be replaced by a new barrel portion. Such modulatory of extruder barrel 210 will reduce the overall reconditioning and repair costs for users of these extruder barrels as well as reduction in labor time and operation time when such extruder barrel 210 needs to be reconditioned. Furthermore, the structural configuration of extruder barrel 210 is also considered advantageous at least because operators of these extruder barrels 210 will have a greater line of sight or clearance when needing to view or inspect the interior space of extruder barrel 210, including inner surfaces or internal coating. With such greater line of sight, the application of the internal coating may be easier and quicker due to the inner surfaces being easily accessible when the extruder barrel 210 is broken down and the first, second, and third barrel portions 212, 214, 216 are separated from one another.

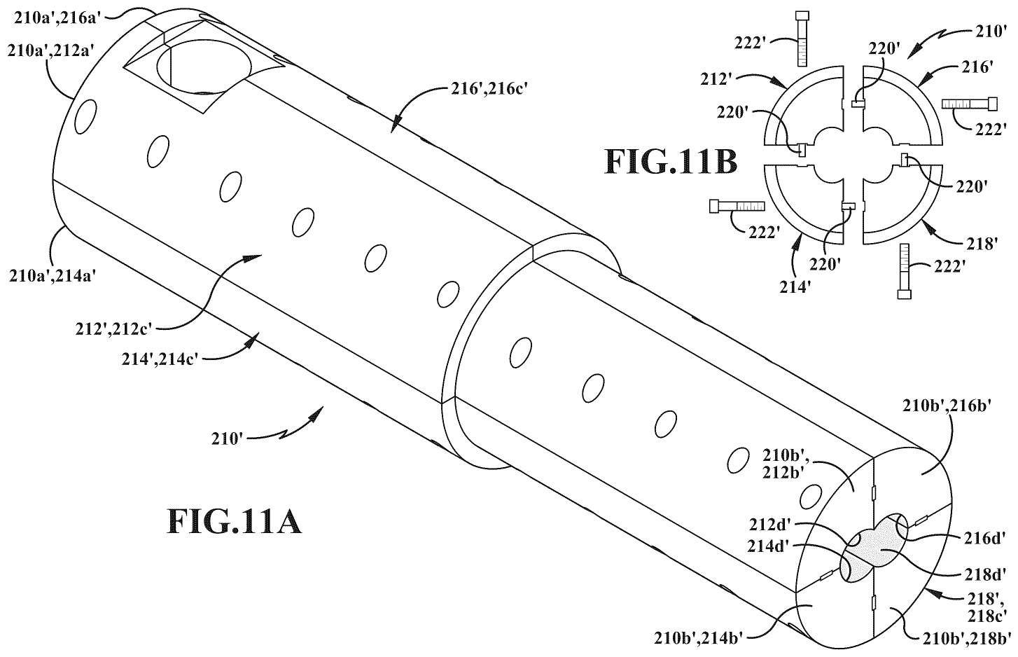

FIGS. 11A-11B illustrate another or third extruder barrel or extruder body 210′. In this embodiment, extruder barrel 210′ includes a first end 210a′, a second end 210b′ that is longitudinally opposite to the first end 210a′, and a longitudinal direction extending from the first end 210a′ to the second end 210b′. Extruder barrel 210′ also defines a pair of main bores along a longitudinal axis of extruder barrel 210′ that extends longitudinally from the first end 210a′ to the second end 210b′ and is accessible at each of the first end 210a′ and the second end 210b′; such pair of bores of the extruder barrel 210′ is discussed in greater detail below.

In the present disclosure, the extruder barrel 210′ is broken into four main components, a first barrel portion 212′, a second barrel portion 214′, a third barrel portion 216′, and a fourth barrel portion 216′ (see FIG. 11B). As discussed in greater detail below, first barrel portion 212′, second barrel portion 214′, third barrel portion 216′, and fourth barrel portion 216′ are removably engaged and/or removably attached with one another such that the first barrel portion 212′, second barrel portion 214′, third barrel portion 216′, and fourth barrel portion 216′ are separable. It should be understood that the structural configuration of first barrel portion 212′, second barrel portion 214′, third barrel portion 216′, and fourth barrel portion 216′ are substantially similar to one another and collectively define the pair of bores for extruder barrel 210′.

As best seen in FIG. 11A, first barrel portion 212′ includes a first end 212a′ that is positioned at the first end 210a′ of the extruder barrel 210′, a second end 212b′ that is longitudinally opposite to the first end 212a′ and is positioned at second end 210b′ of the extruder barrel 210′, and a longitudinal direction extending from the first end 212a′ to the second end 212b′. Still referring to FIG. 11A, first barrel portion 212′ also includes an outer surface 212c′ that extends longitudinally from the first end 212a′ to the second end 212b′ along the longitudinal direction of first barrel portion 212′. First barrel portion 212′ also defines at least one bore 212d′. As best seen in FIG. 11A, the bore 212d″ is defined collectively by an inner or interior surface (such as inner surface 12d of first barrel portion 12 discussed above) that extends longitudinally from the first end 212a′ to the second end 212b′ along the longitudinal direction of first barrel portion 212′. Upon assembly, the bore 212d′ is configured to receive a set of conical extrusion screws of an extrusion system (such as extrusion system 1) for translating extrusion material inside of the extruder barrel 210′.

Still referring to FIG. 11A, second barrel portion 214′ includes a first end 214a′ that is positioned at first end 210a′ of the extruder barrel 210′, a second end 214b′ that is longitudinally opposite to the first end 214a′ and is positioned at the second end 210b′ of the extruder barrel 210′, and a longitudinal direction extending from the first end 214a to the second end 214b. Still referring to FIG. 11A, second barrel portion 214′ also includes an outer surface 214c′ that extends longitudinally from the first end 214a′ to the second end 214b′ along the longitudinal direction of second barrel portion 214′. Second barrel portion 214′ also defines at least one bore 214d′. As best seen in FIG. 11A, bores 214d′ is defined collectively by an inner or interior surface (such as inner surface 14d of second barrel portion 14 discussed above) that extends longitudinally from the first end 214a′ to the second end 214b′ along the longitudinal direction of second barrel portion 214′. Upon assembly, bore 214d′ is also configured to receive a set of conical extrusion screws of an extrusion system (such as extrusion system 1) for translating extrusion material inside of the extruder barrel 210′.

Still referring to FIG. 11A, third barrel portion 216′ includes a first end 216a′ that is positioned at first end 210a′ of the extruder barrel 210′, a second end 216b′ that is longitudinally opposite to the first end 216a′ and is positioned at the second end 216b′ of the extruder barrel 210′, and a longitudinal direction extending from the first end 216a′ to the second end 216b′. Still referring to FIG. 11A, third barrel portion 216′ also includes an outer surface 216c′ that extends longitudinally from the first end 216a′ to the second end 216b′ along the longitudinal direction of third barrel portion 216′. Third barrel portion 216′ also defines at least one bore 216d′. As best seen in FIG. 11A, bores 216d′ is defined collectively by an inner or interior surface (such as inner surfaces 12d, 14d of first and second barrel portions 12,14 discussed above) that extends longitudinally from the first end 216a′ to the second end 216b′ along the longitudinal direction of third barrel portion 216′. Upon assembly, bore 214d′ is also configured to receive a set of conical extrusion screws of an extrusion system (such as extrusion system 1) for translating extrusion material inside of the extruder barrel 210′.

Still referring to FIG. 11A, fourth barrel portion 216′ includes a first end (not shown) that is positioned at first end 210a′ of the extruder barrel 210′, a second end 218b′ that is longitudinally opposite to the first end and is positioned at the second end 210b′ of the extruder barrel 210′, and a longitudinal direction extending from the first end 218a′ to the second end 218b′. Still referring to FIG. 11A, fourth barrel portion 216′ also includes an outer surface 218c′ that extends longitudinally from the first end 218a′ to the second end 218b′ along the longitudinal direction of fourth barrel portion 216′. Fourth barrel portion 216′ also defines at least one bore 218d′. As best seen in FIG. 11A, bores 218d′ is defined collectively by an inner or interior surface (such as inner surfaces 12d, 14d of first and second barrel portions 12,14 discussed above) that extends longitudinally from the first end 218a′ to the second end 218b′ along the longitudinal direction of fourth barrel portion 216′. Upon assembly, bore 218d′ is also configured to receive a set of conical extrusion screws of an extrusion system (such as extrusion system 1) for translating extrusion material inside of the extruder barrel 210′.

It should be understood that the bore 212d′ of first barrel portion 212′, bore 214d′ of second barrel portion 214′, bore 216d′ of third barrel portion 216′, and bore 218d′ of fourth barrel portion 216′ collectively define a main pair of bores for extruder barrel 210′ that extends longitudinally between the first and second ends 210a′, 210b′ of extruder barrel 210′ substantially similarly to the pair of bores 20a, 20b of the extruder barrel 10 discussed above.

Extruder barrel 210′ also includes a set of alignment pins or dowels 220′ to align the first barrel portion 212′, the second barrel portion 214′, the third barrel portion 216′, and fourth barrel portion 218′ with one another for ease of assembly. Prior to assembly, the set of alignment pins 220′ may be engaged and/or seated with the first, second, third, and fourth barrel portions 212′, 214′, 216′, 218′ inside a respective alignment cavity or hole similar to the engagement of the set of alignment pins 16 with extruder barrel 10. During assembly, the set of alignment pins 220′ may then be introduced and aligned with receiving alignment cavities or holes defined in the receiving barrel portion. For example, and as best seen in FIG. 11B, the set of alignment pins 220′ preinstalled in the first barrel portion 212′ is to be received by receiving alignment cavities or holes defined in the second barrel portion 214′. Once aligned, receiving barrel portion (such as second barrel portion 214′ in the example above) may be moved onto the first barrel portion 212′ while the set of alignment pins 220′ are housed inside of receiving alignment cavities or holes defined of the receiving barrel portion until the two barrel portions directly contact one another.

Extruder barrel 210′ also includes a set of connectors 222′ that removably engage first, second, third, and fourth barrel portions 212′, 214′, 216′, 218′ with one another. Particularly, and as best seen in FIG. 11B, the set of connectors 222′ removably engages first, second, third, and fourth barrel portions 212′, 214′, 216′, 218′ with one another. In this embodiment, the set of connectors 222′ pass through a set of openings defined in one barrel portion (such as first barrel portion 212′) and threadedly engage with a set of threaded cavities defined in another barrel portion (such as second barrel portion 214′) to engage both barrel portions with one another.

In other exemplary embodiments, other mechanical configurations may be used to removably engage first, second, third, and fourth barrel portions 212′, 214′, 216′, 218′ with or without the set of connectors 222′. In one exemplary embodiment, a separate attachment component may be used to removably engage first, second, third, and fourth barrel portions 212′, 214′, 216′, 218′ with one another.

Similar to extruder barrel 10 discussed above, it should be understood that bores 212d′, 214d′, 216d′, 218d′ of extruder barrel 210′ includes an internal coating. In the present disclosure, internal coating is applied along the inner surfaces of first, second, third, and fourth barrel portions 212′, 214′, 216′, 218′ inside of bores 212d′, 214d′, 216d′, 218d′; such internal coating formed inside of first, second, third, and fourth barrel portions 212′, 214′, 216′, 218′ is denoted by a grey-tone shown in FIG. 11A. It should be understood that internal coating applied to the extruder barrel 210′ may be any suitable corrosion protection and/or wear resistant inlay or coating as discussed herein.

The structural configuration of extruder barrel 210′ is considered advantageous at least because operators and users of extruder barrel 210′ are able to recondition, repair, and/or rebuild the existing extruder barrel 210′ without completely disposing of the extruder barrel 210′. As discussed above, first, second, third, and fourth barrel portions 212′, 214′, 216′, 218′ are releasably engaged with one another thus allowing operators and users to separate such first, second, third, and fourth barrel portions 212′, 214′, 216′, 218′ from one another for repair and reconditioning reasons. As such, when one of the first, second, third, and fourth barrel portions 212′, 214′, 216′, 218′ is worn or damaged due to corrosion or wear, operators of extruder barrel 210′ may simply remove the worn barrel portion to which the worn barrel portion may be repaired or may be replaced by a new barrel portion. Such modulatory of extruder barrel 210′ will reduce the overall reconditioning and repair costs for users of these extruder barrels as well as reduction in labor time and operation time when such extruder barrel 210′ needs to be reconditioned. Furthermore, the structural configuration of extruder barrel 210′ is also considered advantageous at least because operators of these extruder barrels 210′ will have a greater line of sight or clearance when needing to view or inspect the interior space of extruder barrel 210′, including inner surfaces or internal coating. With such greater line of sight, the application of the internal coating may be easier and quicker due to the inner surfaces being easily accessible when the extruder barrel 210′ is broken down and the first, second, third, and fourth barrel portions 212′, 214′, 216′, 218′ are separated from one another.

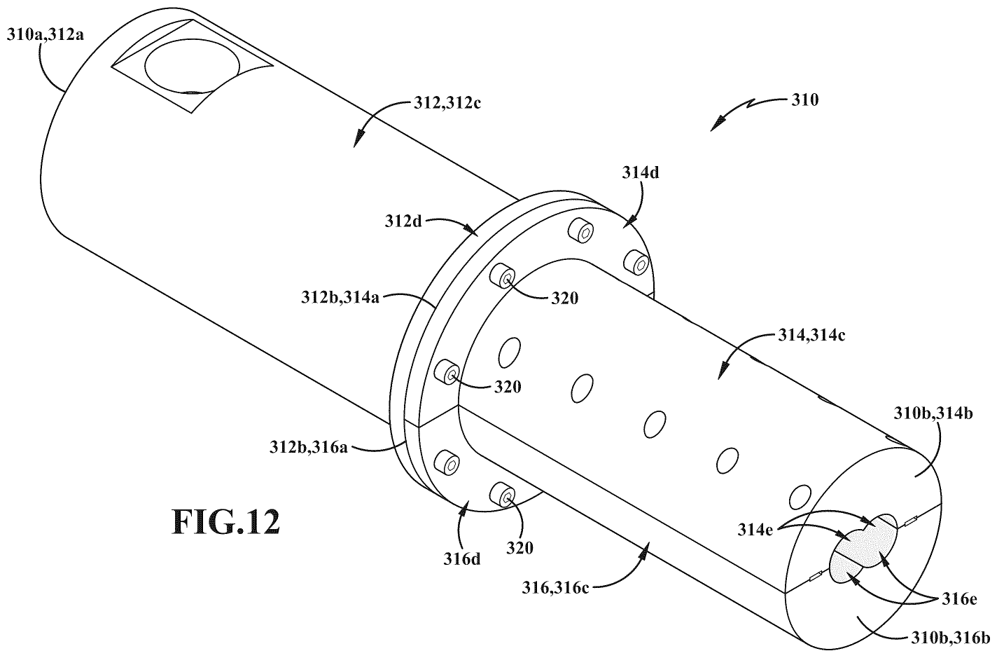

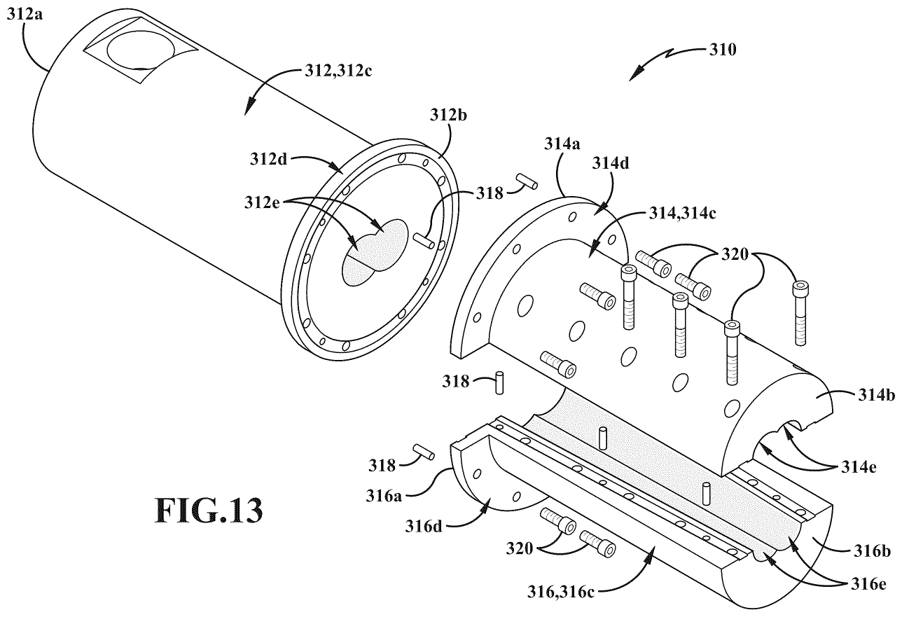

FIGS. 12-13 illustrate another or fourth extruder barrel or extruder body 310. In this embodiment, extruder barrel 310 includes a first end 310a, a second end 310b that is longitudinally opposite to the first end 310a, and a longitudinal direction extending from the first end 310a to the second end 310b. Extruder barrel 310 also defines a main pair of bores along a longitudinal axis of extruder barrel 310 that extends longitudinally from the first end 310a to the second end 310b that is accessible at each of the first end 310a and the second end 310b; such main pair of bores of the extruder barrel 310 is discussed in greater detail below.

In the present disclosure, the extruder barrel 310 is broken into three main components: a first or feed barrel portion 312, a second or upper dispense barrel portion 314, a third or lower dispense barrel portion 316 (see FIG. 13). As discussed in greater detail below, first barrel portion 312 is removably engaged with the second barrel portion 314 and third barrel portion 316 such that the first barrel portion 312 and the second barrel portion 314 and the third barrel portion 316 are separable. Additionally, the second barrel portion 314 and the third barrel portion 316 are also removably engaged with one another such that the second barrel portion 314 and the third barrel portion 316 are separable. Such separability of the second barrel portion 314 and the third barrel portion 316 allows users or operators of extruder barrel 310 to have a full line of sight along the interior surfaces of the second barrel portion 314 and the third barrel portion 316 proximate the dispensing end of extruder barrel 310 for repairing or refurbishing the second barrel portion 314 and/or the third barrel portion 316 similar to the first and second barrel portions 12, 14 of extruder barrel 10 discussed above.

As best seen in FIG. 12, first barrel portion 312 includes a first end 312a that is positioned at the first end 310a of the extruder barrel 310, a second end 312b that is longitudinally opposite to the first end 312a and is positioned between the first and second ends 310a, 310b of the extruder barrel 310, and a longitudinal direction extending from the first end 312a to the second end 312b. Still referring to FIG. 12, first barrel portion 312 also includes an outer surface 312c that extends longitudinally from the first end 312a to the second end 312b along the longitudinal direction of first barrel portion 312. First barrel portion 312 also includes a flange or attachment member 312d that extends radially outward from the second end 312b to removably engage the first barrel portion 312 with the second barrel portion 314; such assembly of extruder barrel 310 is discussed in greater detail below.

In this illustrated embodiment, however, first barrel portion 312 defines a first pair of bores 312e. As best seen in FIG. 13, the first pair of bores 312e is defined collectively by an inner or interior surface (such as inner surface 12d of first barrel portion 12) that extends longitudinally from the first end 312a to the second end 312b along the longitudinal direction of first barrel portion 312. Upon assembly, the first pair of bores 312e is configured to receive a set of conical extrusion screws of an extrusion system (such as extrusion system 1) for translating extrusion material inside of the extruder barrel 310.

Referring to FIG. 13, second barrel portion 314 includes a first end 314a that is positioned between first and second ends 310a, 310b of the extruder barrel 310, a second end 314b that is longitudinally opposite to the first end 314a and is positioned at the second end 310b of the extruder barrel 310, and a longitudinal direction extending from the first end 314a to the second end 314b. Still referring to FIG. 13, second barrel portion 314 also includes an outer surface 314c that extends longitudinally from the first end 314a to the second end 314b along the longitudinal direction of second barrel portion 314. Second barrel portion 314 also includes a first flange 314d that extends radially outward from the first end 314a to removably engage the second barrel portion 314 with the first barrel portion 312 at flange 312d; such assembly of extruder barrel 310 is discussed in greater detail below.

In this illustrated embodiment, however, second barrel portion 314 also defines a second pair of bores 314e. As best seen in FIG. 13, the second pair of bores 314e is defined collectively by an inner or interior surface (such as inner surface 14d of second barrel portion 14) that extends longitudinally from the first end 314a to the second end 314b along the longitudinal direction of second barrel portion 314. Upon assembly, the second pair of bores 314e is also configured to receive a set of conical extrusion screws of an extrusion system (such as extrusion system 1) for translating extrusion material inside of the extruder barrel 310.

Referring to FIG. 13, third barrel portion 316 includes a first end 316a that is positioned between first and second ends 310a, 310b of the extruder barrel 310, a second end 316b that is longitudinally opposite to the first end 316a and is positioned at second end 310b of the extruder barrel 310, and a longitudinal direction extending from the first end 316a to the second end 316b. Still referring to FIG. 13, third barrel portion 316 also includes an outer surface 316c that extends longitudinally from the first end 316a to the second end 316b along the longitudinal direction of third barrel portion 316. Third barrel portion 316 also includes a flange or attachment member 316d that extends radially outward from the first end 316a to removably engage the third barrel portion 316 with the first barrel portion 312 at flange 312d; such assembly of extruder barrel 310 is discussed in greater detail below.

In this illustrated embodiment, however, third barrel portion 316 defines a third pair of bores 316e. As best seen in FIG. 13, the third pair of bores 316e is defined collectively by an inner or interior surface (such as inner surfaces 12d, 14d of first and second barrel portions 12, 14 discussed above) that extends longitudinally from the first end 316a to the second end 316b along the longitudinal direction of third barrel portion 316. Upon assembly, the third pair of bores 316e is configured to receive a set of conical extrusion screws of an extrusion system (such as extrusion system 1) for translating extrusion material inside of the extruder barrel 310. It should be understood that the first pair of bores 312e of first barrel portion 312, second pair of bores 314e of second barrel portion 314, and third pair of bores 316e of third barrel portion 316 collectively define a main pair of bores that extends longitudinally between the first and second ends 310a, 310b of extruder barrel 310 substantially similarly to the pair of bores 20a, 20b of the extruder barrel 10 discussed above.

Extruder barrel 310 also includes sets of alignment pins or dowels 318 to align the first barrel portion 312 with the second barrel portion 314 and the third barrel portion 316 for ease of assembly and to align the second barrel portion 314 and the third barrel portion 316 with one another for ease of assembly. Prior to assembly, a first group of alignment pins of the set of alignment pins 318 may be engaged and/or seated with the second end 312b of the first barrel portion 312 inside a respective alignment cavity or hole similar to the engagement of the set of alignment pins 318 with extruder barrel 310. During assembly, the first group of alignment pins of set of alignment pins 318 may then be introduced and aligned with the second barrel portion 314 via receiving alignment cavities or holes defined in the first end 314a of the second barrel portion 314 and with receiving alignment cavities or holes defined in the first end 316a of the third barrel portion 316. Once aligned, the second barrel portion 314 and the third barrel portion 316 may be moved onto the first barrel portion 312 while the set of alignment pins 318 are housed inside of receiving alignment cavities or holes defined in the first ends 314a, 316a of the second and third barrel portions 314, 316 until flanges 312d, 314d, 316d of first, second, and third barrel portions 312, 314, 316 directly contact one another.

Similarly, a second group of alignment pins of the set of alignment pins 318 accomplishes a substantially similar alignment technique between the second barrel portion 314 and the third barrel portion 316 as discussed in aligning the first and second barrel portions 12, 14 of extruder 10. For brevity, the operation of aligning the first and second barrel portions 12, 14 of extruder 10 with the set of alignment pins 318 applies equally to the operation of aligning the second and third barrel portions 314, 316 of extruder 310 with the second group of alignment pins of the set of alignment pins 318.

Extruder barrel 310 also includes a set of connectors 320 that removably engage first, second, and third barrel portions 312, 314, 316 with one another. Particularly, and as best seen in FIG. 13, a first group of connectors of the set of connectors 320 engages with flange 312d of first barrel portions 312 and flange 314d of the second barrel portion 314 to removably engage first and second barrel portions 312, 314 with one another. In this embodiment, first group of connectors of the set of connectors 320 pass through a set of openings defined in the flange 314d of the second barrel portion 314 and threadedly engage with a set of threaded cavities defined in flange 312d of the first barrel portion 312. Similarly, and as best seen in FIG. 13, a second group of connectors of the set of connectors 320 engages with flange 316d of third barrel portions 316 and flange 312d of the first barrel portion 312 to removably engage first and third barrel portions 312, 316 with one another. In this embodiment, second group of connectors of the set of connectors 320 pass through a set of openings defined in flange 316d of the third barrel portion 316 and threadedly engage with the set of threaded cavities defined in flange 312d of the first barrel portion 316.

Still referring to the set of connectors 320, and as best seen in FIG. 13, a third group of connectors of the set of connectors 320 engages with the second and third barrel portions 314, 316 to removably engage second and third barrel portions 314, 316 with one another. In this embodiment, third group of connectors of the set of connectors 320 pass through a set of passageways defined the second barrel portion 314 and threadedly engage with a set of threaded cavities defined in the third barrel portion 316. Such engagement between the second and third barrel portions 314, 316 by the third group of connectors of the set of connectors 320 is identical to the engagement between the first and second barrel portions 12, 14 by the set of connectors 18 of extruder barrel 10 discussed above.

Similar to extruder barrel 10 discussed above, it should be understood that first, second, and third pairs of bores 312e, 314e, 316e of extruder barrel 310 includes an internal coating. In the present disclosure, internal coating is applied along the inner surfaces of first, second, and third barrel portions 312, 314, 316 inside of first, second, and third pairs of bores 312e, 314e, 316e; such internal coating formed inside of first, second, and third barrel portions 312, 314, 316 is denoted by a grey-tone shown in FIGS. 12-13. It should be understood that internal coating applied to the extruder barrel 310 may be any suitable corrosion protection and/or wear resistant inlay or coating as discussed herein.

The structural configuration of extruder barrel 310 is considered advantageous at least because operators and users of extruder barrel 310 are able to recondition, repair, and/or rebuild the existing extruder barrel 310 without completely disposing of the extruder barrel 310. As discussed above, first, second, and third barrel portions 312, 314, 316 are releasably engaged with one another thus allowing operators and users to separate such first, second, and third barrel portions 312, 314, 316 from one another for repair and reconditioning reasons. As such, when one or more of the first, second, third, and fourth barrel portions 312, 314, 316 is worn or damaged due to corrosion or wear, operators of extruder barrel 310 may simply remove the worn barrel portion to which the worn barrel portion may be repaired or may be replaced by new barrel portion. Such modulatory of extruder barrel 310 will reduce the overall reconditioning and repair costs for users of these extruder barrels as well as reduction in labor time and operation time when such extruder barrel 310 needs to be reconditioned. Furthermore, the structural configuration of extruder barrel 310 is also considered advantageous at least because operators of these extruder barrels 310 will have a greater line of sight or clearance when needing to view or inspect the interior space of extruder barrel 310, including inner surfaces or internal coating of the second and third barrel portions 314, 316. With such greater line of sight, the application of the internal coating may be easier and quicker due to the inner surfaces being easily accessible when the extruder barrel 310 is broken down and the second and third barrel portions 314, 316 are separated from one another.

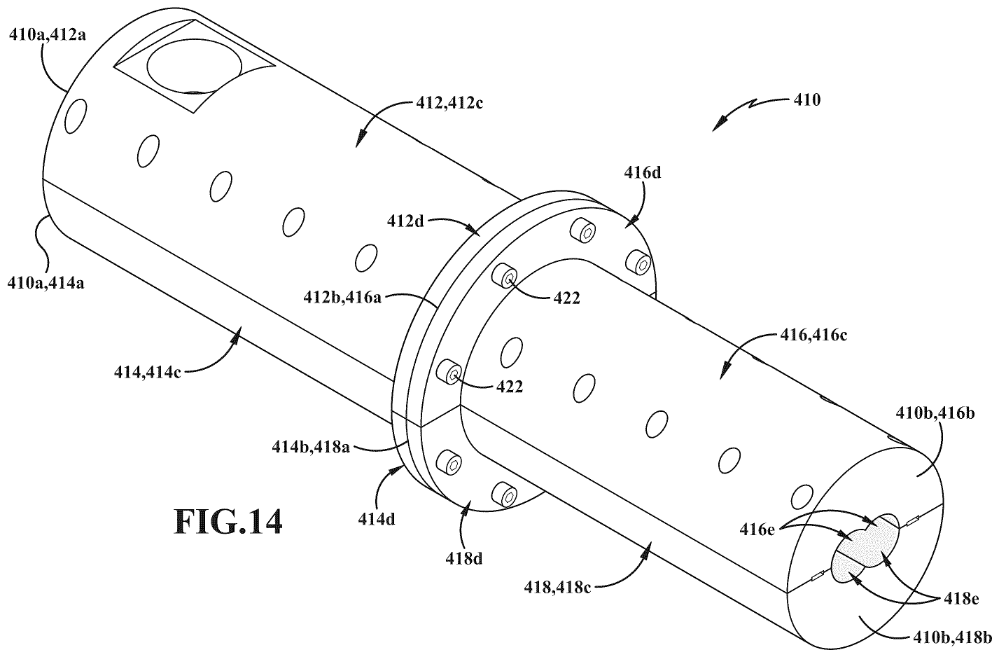

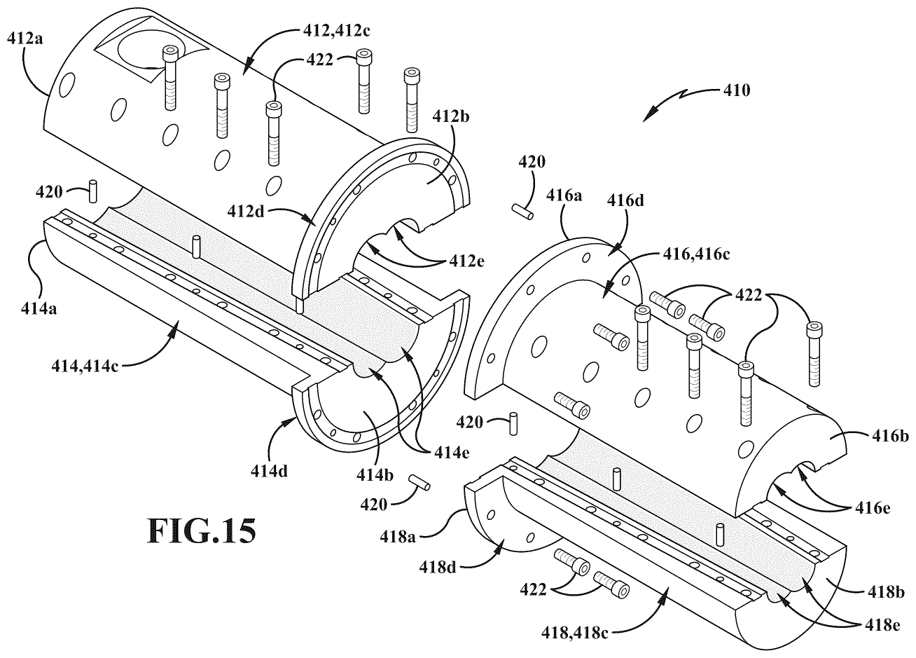

FIGS. 14-15 illustrate another or fifth extruder barrel or extruder body 410. In this embodiment, extruder barrel 410 includes a first end 410a, a second end 410b that is longitudinally opposite to the first end 410a, and a longitudinal direction extending from the first end 410a to the second end 410b. Extruder barrel 410 also defines a main pair of bores along a longitudinal axis of extruder barrel 410 that extends longitudinally from the first end 410a to the second end 410b that is accessible at each of the first end 410a and the second end 410b; such bore of the extruder barrel 410 is discussed in greater detail below.

In the present disclosure, the extruder barrel 410 is broken into four main components: a first barrel portion 412, a second barrel portion 414, a third barrel portion 416, and a fourth barrel portion 418 (see FIG. 15). As discussed in greater detail below, first barrel portion 412, second barrel portion 414, third barrel portion 416, and fourth barrel portions 418 are removably engaged and/or removably attached with one another such that the first barrel portion 412, the second barrel portion 414, the third barrel portion 416, and fourth barrel portion 418 are separable. It should be understood that the structural configuration of first barrel portion 412 and second barrel portion 414 are mirror-images of one another, relative to a longitudinal axis of extruder barrel 310, once the first barrel portion 412 and second barrel portion 414 are assembled with one another. Similarly, it should be understood that the structural configuration of third barrel portion 416 and fourth barrel portion 418 are mirror-images of one another, relative to a longitudinal axis of extruder barrel 410, once the third barrel portion 416 and fourth barrel portion 418 are assembled with one another.

As best seen in FIG. 14, first barrel portion 412 includes a first end 412a that is positioned at the first end 410a of the extruder barrel 410, a second end 412b (see FIG. 15) that is longitudinally opposite to the first end 412a and is positioned between the first and second ends 410a, 410b of the extruder barrel 410, and a longitudinal direction extending from the first end 412a to the second end 412b. Still referring to FIG. 14, first barrel portion 412 also includes an outer surface 412c that extends longitudinally from the first end 412a to the second end 412b along the longitudinal direction of first barrel portion 412. First barrel portion 412 also includes a flange or attachment member 412d that extends radially outward from the second end 412b to removably engage the first barrel portion 412 with the third barrel portion 416; such assembly of extruder barrel 410 is discussed in greater detail below.

In this illustrated embodiment, however, first barrel portion 412 defines a first pair of cavities 412e. As best seen in FIG. 15, the first pair of cavities 412e is defined collectively by an inner or interior surface (such as inner surface 12d of first barrel portion 12 discussed above) that extends longitudinally from the first end 412a to the second end 412b along the longitudinal direction of first barrel portion 412.

Referring to FIG. 14, second barrel portion 414 includes a first end 414a that is positioned at first end 410a of the extruder barrel 410, a second end 314b (see FIG. 15) that is longitudinally opposite to the first end 414a and is positioned between first and second ends 410a, 410b of the extruder barrel 410, and a longitudinal direction extending from the first end 414a to the second end 414b. Still referring to FIG. 14, second barrel portion 414 also includes an outer surface 414c that extends longitudinally from the first end 414a to the second end 414b along the longitudinal direction of second barrel portion 414. Second barrel portion 414 also includes flange or attachment member 414d that extends radially outward from the second end 414b to removably engage the second barrel portion 414 with the fourth barrel portion 418; such assembly of extruder barrel 410 is discussed in greater detail below.

In this illustrated embodiment, however, second barrel portion 414 also defines a second pair of cavities 414e. As best seen in FIG. 15, the second pair of cavities 414e is defined collectively by an inner or interior surface (such as inner surface 14d of second barrel portion 14) that extends longitudinally from the first end 414a to the second end 414b along the longitudinal direction of second barrel portion 414. Upon assembly with the first barrel portion 412, the first pair of cavities 412e of first barrel portion 412 and the second pair of cavities 414e of second barrel portion 414 collectively define a first pair of bores that is configured to receive a set of conical extrusion screws of an extrusion system (such as extrusion system 1) for translating extrusion material inside of the extruder barrel 410.

Referring to FIG. 14, third barrel portion 416 includes a first end 416a that is positioned between first and second ends 410a, 410b of the extruder barrel 410, a second end 416b that is longitudinally opposite to the first end 416a and is positioned at second end 410b of the extruder barrel 410, and a longitudinal direction extending from the first end 416a to the second end 416b. Still referring to FIG. 14, third barrel portion 416 also includes an outer surface 416c that extends longitudinally from the first end 416a to the second end 416b along the longitudinal direction of third barrel portion 416. Third barrel portion 416 also includes a flange or attachment member 416d that extends radially outward from the first end 416a to removably engage the third barrel portion 416 with the first barrel portion 412 at flange 412d; such assembly of extruder barrel 410 is discussed in greater detail below.

In this illustrated embodiment, however, third barrel portion 416 defines a third pair of cavities 416e. As best seen in FIG. 15, the third pair of cavities 416e is defined collectively by an inner or interior surface (such as inner surfaces 12d, 14d of first and second barrel portions 12, 14) that extends longitudinally from the first end 416a to the second end 416b along the longitudinal direction of third barrel portion 416. Upon assembly, the third pair of cavities 416e is configured to receive a set of conical extrusion screws of an extrusion system (such as extrusion system 1) for translating extrusion material inside of the extruder barrel 410.

Referring to FIG. 14, fourth barrel portion 418 includes a first end 418a that is positioned between first and second ends 410a, 410b of the extruder barrel 410, a second end 418b that is longitudinally opposite to the first end 418a and is positioned at second end 410b of the extruder barrel 410, and a longitudinal direction extending from the first end 418a to the second end 418b. Still referring to FIG. 14, fourth barrel portion 418 also includes an outer surface 418c that extends longitudinally from the first end 418a to the second end 418b along the longitudinal direction of fourth barrel portion 418. Fourth barrel portion 418 also includes flange or attachment member 418d that extends radially outward from the first end 418a to removably engage the fourth barrel portion 418 with the second barrel portion 414 at flange 414d; such assembly of extruder barrel 410 is discussed in greater detail below.

In this illustrated embodiment, however, fourth barrel portion 418 also defines a fourth pair of cavities 418e. As best seen in FIG. 15, the fourth pair of cavities 418e is defined collectively by an inner or interior surface (such as inner surfaces 12d, 14d of first and second barrel portions 12, 14) that extends longitudinally from the first end 418a to the second end 418b along the longitudinal direction of fourth barrel portion 418. Upon assembly with the third barrel portion 416, the third pair of cavities 416e of third barrel portion 416 and the fourth pair of cavities 418e of fourth barrel portion 418 collectively define a second pair of bores that is configured to receive a set of conical extrusion screws of an extrusion system (such as extrusion system 1) for translating extrusion material inside of the extruder barrel 410. It should be understood that the first pair of cavities 412e of first barrel portion 412, second pair of cavities 414e of second barrel portion 414, third pair of cavities 416e of third barrel portion 416, and fourth pair of cavities 418e of fourth barrel portion 418 collectively define a main pair of bores that extends longitudinally between the first and second ends 410a, 410b of extruder barrel 410 substantially similarly to the pair of bores 20a, 20b of the extruder barrel 10 discussed above.

Extruder barrel 410 also includes sets of alignment pins or dowels 420 to align the first barrel portion 412, the second barrel portion 414, the third barrel portion 416, and fourth barrel portion 418 with one another for ease of assembly. In one instance, a first group of alignment pins of the set of alignment pins 420 is used to align and engage the first and second barrel portions 412, 414 with one another (see FIG. 15). In another instance, a second group of alignment pins of the set of alignment pins 420 is used to align and engage the third and fourth barrel portions 416, 418 with one another (see FIG. 15). In yet another instance, a third group of alignment pins of the set of alignment pins 420 is used to align and engage the first and second barrel portions 412, 414, collectively, with the third and fourth barrel portions 416, 418, collectively, at the flanges 412d, 414d, 416d, 418d (see FIG. 15).

Extruder barrel 410 also includes a set of connectors 422 that removably engage first, second, third, and fourth barrel portions 412, 414, 416, 418 with one another. In one instance, and as best seen in FIG. 15, a first group of connectors of the set of connectors 422 engages the first barrel portion 412 and the second barrel portion 414 with one another similar to the connectors 18 of the extruder barrel 10 discussed above. In another instance, and as best seen in FIG. 15, a second group of connectors of the set of connectors 422 engages the third barrel portion 416 and the fourth barrel portion 418 with one another similar to the connectors 18 of the extruder barrel 10 discussed above. In yet another instance, a third group of connectors of the set of connectors 422 engages the first and second barrel portions 412, 414, collectively, with the third and fourth barrel portions 416, 418, collectively, at flanges 412d, 414d, 416d, 418d.

It should be noted that first, second, third, and fourth barrel portions 412, 414, 416, 418 may also define pairs of recesses (similar to pair of recesses 12j, 14j of first and second barrel portions 12, 14 mentioned above). Such definition of these pairs of recesses reduces the contact points or surface area along internal surface between the first and second barrel portions 412, 414 and between the third and fourth barrel portions 416, 418. With such reduction in surface area, a set of connectors of the extruder barrel 410 may be torqued and/or fastened at a lower torque value while still maintaining an increased sealing pressure between first and second barrel portions 412, 414 and between the third and fourth barrel portions 416, 418.

Similar to extruder barrel 10 discussed above, it should be understood that first, second, third, and fourth pairs of cavities 412e, 414e, 416e, 418e of extruder barrel 410 includes an internal coating. In the present disclosure, internal coating is applied along the inner surfaces of first, second, third, and fourth barrel portions 412, 414, 416, 418 inside of first, second, third, and fourth pairs of cavities 412e, 414e, 416e, 418e; such internal coating formed inside of first, second, third, and fourth barrel portions 412, 414, 416, 418 is denoted by a grey-tone shown in FIGS. 14-15. It should be understood that internal coating applied to the extruder barrel 410 may be any suitable corrosion protection and/or wear resistant inlay or coating as discussed herein.

The structural configuration of extruder barrel 410 is considered advantageous at least because operators and users of extruder barrel 410 are able to recondition, repair, and/or rebuild the existing extruder barrel 410 without completely disposing of the extruder barrel 410. As discussed above, first, second, third, and fourth barrel portions 412, 414, 416, 418 are releasably engaged with one another thus allowing operators and users to separate such first, second, third, and fourth barrel portions 412, 414, 416, 418 from one another for repair and reconditioning reasons. As such, when one or more of the first, second, third, and fourth barrel portions 412, 414, 416, 418 is worn or damaged due to corrosion or wear, operators of extruder barrel 410 may simply remove the worn barrel portion to which the worn barrel portion may be repaired or may be replaced by new barrel portion. Such modulatory of extruder barrel 410 will reduce the overall reconditioning and repair costs for users of these extruder barrels as well as reduction in labor time and operation time when such extruder barrel 410 needs to be reconditioned. Furthermore, the structural configuration of extruder barrel 410 is also considered advantageous at least because operators of these extruder barrels 410 will have a greater line of sight or clearance when needing to view or inspect the interior space of extruder barrel 410, including inner surfaces or internal coating. With such greater line of sight, the application of the internal coating may be easier and quicker due to the inner surfaces being easily accessible when the extruder barrel 410 is broken down and the first, second, third, and fourth barrel portions 412, 414, 416, 418 are separated from one another.

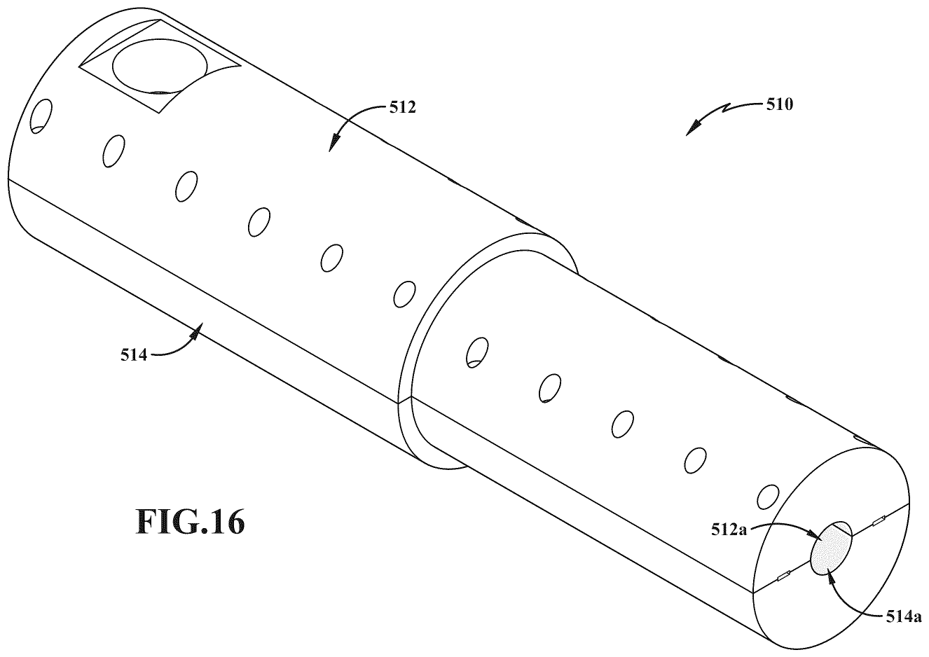

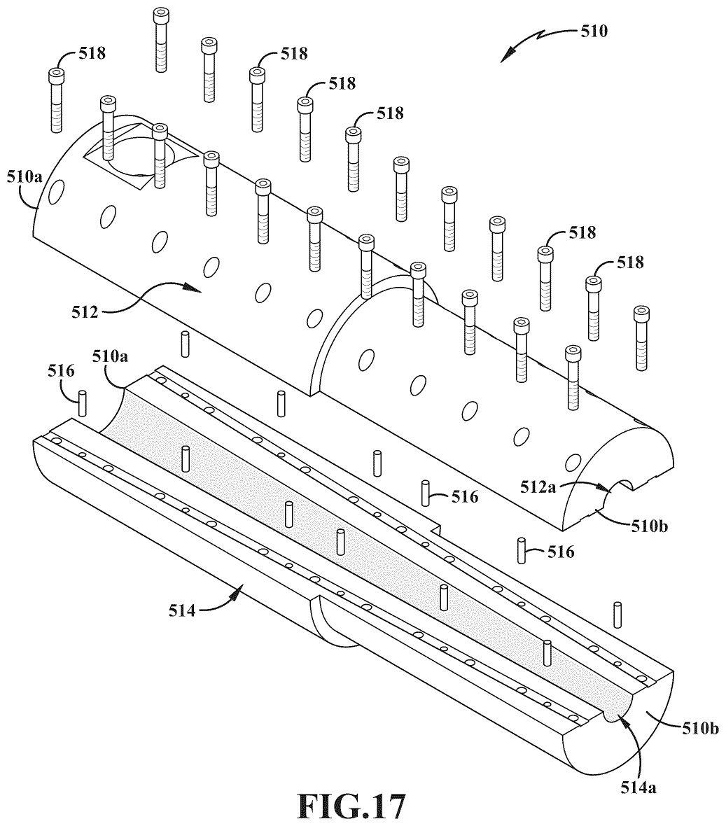

FIGS. 16-17 illustrate yet another or sixth extruder barrel or extruder body 510. In this embodiment, extruder barrel 510 includes a first end 510a, a second end 510b that is longitudinally opposite to the first end 510a, and a longitudinal direction extending from the first end 510a to the second end 510b. Extruder barrel 510 also defines a single bore along a longitudinal axis of extruder barrel 510 that extends longitudinally from the first end 510a to the second end 510b that is accessible at each of the first end 510a and the second end 510b; such bore of the extruder barrel 510 is discussed in greater detail below.

In the present disclosure, the extruder barrel 510 is broken into two main components, a first or upper barrel portion 512 and a second or lower barrel portion 514 (see FIG. 17). As discussed in greater detail below, first barrel portion 512 and second barrel portion 514 are removably engaged with and/or removably attached with one another such that the first barrel portion 512 and the second barrel portion 514 are separable. It should be understood that the structural configuration of first barrel portion 512 and second barrel portion 514 are mirror-images of one another, relative to a longitudinal axis of extruder barrel 510, once the first barrel portion 512 and second barrel portion 514 are assembled with one another. As such, first barrel portion 512 and second barrel portion 514 are substantially similar to first barrel portion 12 and second barrel portion 14 of extruder barrel 10 discussed above, except as detailed below.

In this illustrated embodiment, however, first barrel portion 512 and second barrel portion 514 each defines a single cavity 512a, 514a. As best seen in FIG. 17, each cavity 512a, 514a is defined collectively by an inner or interior surface (such as inner surfaces 12d, 14d of first and second barrel portions 12, 14) of the respective barrel portion 512, 514 and extends longitudinally along a longitudinal direction of the respective barrel portion 512, 514. Upon assembly, cavities 512a, 514a of first and second barrel portion 512, 514 collectively define or form a single bore that extends longitudinally along a longitudinal direction of the extruder barrel 510. It should be noted that the bore of extruder barrel 510 is conically-shaped such that bore defines a first diameter at the first end 510a of extruder barrel 510 and progresses inwardly to a second diameter at the second end 510b of extruder barrel 510 that is less than the first diameter.

Extruder barrel 510 also includes a set of alignment pins or dowels 516 to align the first barrel portion 512 and the second barrel portion 514 with one another for ease of assembly; such use of the set of alignment pins 516 is identical to the use of the set of alignment pins 16 of extruder barrel 10 discussed above. Extruder barrel 510 also includes a set of connectors 518 that removably engage first and second barrel portions 512, 514 with one another; such use of the set of connectors 518 is identical to the use of the set of connectors 18 of extruder barrel 10 discussed above.

Similar to extruder barrel 10 discussed above, it should be understood that cavities of first and second barrel portions 512, 514 of extruder barrel 510 includes an internal coating. In the present disclosure, internal coating is applied along the inner surfaces of first and second barrel portions 512, 514 inside of cavities 512a, 514a; such internal coating formed inside of first and second barrel portions 512, 514 is denoted by a grey-tone shown in FIGS. 16-17. It should be understood that internal coating applied to the extruder barrel 510 may be any suitable corrosion protection and/or wear resistant inlay or coating as discussed herein.

The structural configuration of extruder barrel 510 is considered advantageous at least because operators and users of extruder barrel 510 are able to recondition, repair, and/or rebuild the existing extruder barrel 510 without completely disposing of the extruder barrel 510. As discussed above, first and second barrel portions 512, 514 are releasably engaged with one another thus allowing operators and users to separate such first and second barrel portions 512, 514 from one another for repair and reconditioning reasons. As such, when the first barrel portion 512 or second barrel portion 514 is worn or damaged due to corrosion or wear, operators of extruder barrel 510 may simply remove the worn barrel portion to which the worn barrel portion may be repaired or may be replaced by new barrel portion. Such modulatory of extruder barrel 510 will reduce the overall reconditioning and repair costs for users of these extruder barrels as well as reduction in labor time and operation time when such extruder barrel 510 needs to be reconditioned. Furthermore, the structural configuration of extruder barrel 510 is also considered advantageous at least because operators of these extruder barrels 510 will have a greater line of sight or clearance when needing to view or inspect the interior space of extruder barrel 510, including inner surfaces or internal coating. With such greater line of sight, the application of the internal coating may be easier and quicker due to the inner surfaces being easily accessible when the extruder barrel 510 is broken down and the first and second barrel portions 512, 514 are separated from one another.

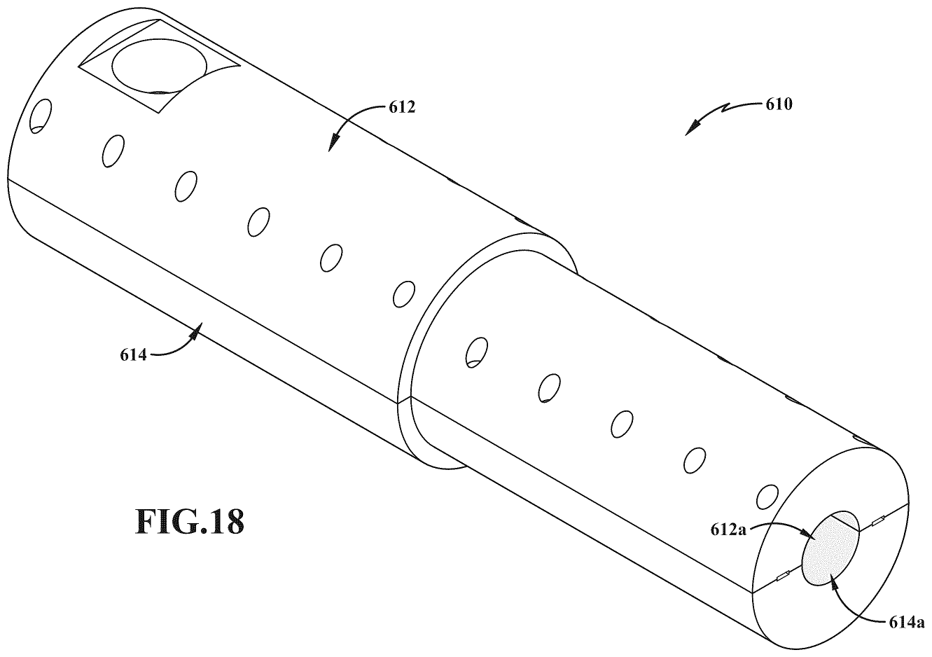

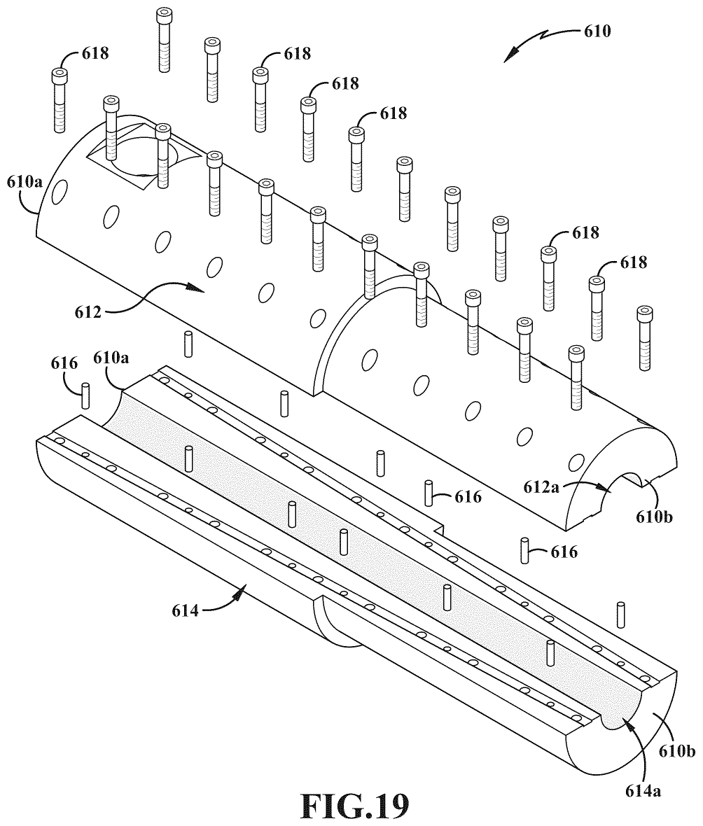

FIGS. 18-19 illustrate yet another or seventh extruder barrel or extruder body 610. In this embodiment, extruder barrel 610 includes a first end 610a, a second end 610b that is longitudinally opposite to the first end 610a, and a longitudinal direction extending from the first end 610a to the second end 610b. Extruder barrel 610 also defines a single bore along a longitudinal axis of extruder barrel 610 that extends longitudinally from the first end 610a to the second end 610b that is accessible at each of the first end 610a and the second end 610b; such bore of the extruder barrel 610 is discussed in greater detail below.

In the present disclosure, the extruder barrel 610 is broken into two main components, a first or upper barrel portion 612 and a second or lower barrel portion 614 (see FIG. 19). As discussed in greater detail below, first barrel portion 612 and second barrel portion 614 are removably engaged with and/or removably attached with one another such that the first barrel portion 612 and the second barrel portion 614 are separable. It should be understood that the structural configuration of first barrel portion 612 and second barrel portion 614 are mirror-images of one another, relative to a longitudinal axis of extruder barrel 610, once the first barrel portion 612 and second barrel portion 614 are assembled with one another. As such, first barrel portion 612 and second barrel portion 614 are substantially similar to first barrel portion 12 and second barrel portion 14 of extruder barrel 10 discussed above, except as detailed below.

In this illustrated embodiment, however, first barrel portion 612 and second barrel portion 614 each defines a single cavity 612a, 614a. As best seen in FIG. 19, each cavity 612a, 614a is defined collectively by an inner or interior surface (such as inner surfaces 12d, 14d) of the respective barrel portion 612, 614 and extends longitudinally along a longitudinal direction of the respective barrel portion 612, 614. Upon assembly, the cavities 612a, 614a of first and second barrel portion 612, 614 collectively define or form a single bore that extends longitudinally along a longitudinal direction of the extruder barrel 610. It should be noted that the bore of extruder barrel 610 is parallel-shaped such that bore defines the same diameter along the entire length of extruder barrel 610 between the first end 610a of extruder barrel 610 to the second end 610b of extruder barrel 610.

Extruder barrel 610 also includes a set of alignment pins or dowels 616 to align the first barrel portion 612 and the second barrel portion 614 with one another for ease of assembly (see FIG. 19); such use of the set of alignment pins 616 is identical to the use of the set of alignment pins 16 of extruder barrel 10 discussed above. Extruder barrel 610 also includes a set of connectors 618 that removably engage first and second barrel portions 612, 614 with one another (see FIG. 19); such use of the set of connectors 618 is identical to the use of the set of connectors 18 of extruder barrel 10 discussed above.

Similar to extruder barrel 10 discussed above, it should be understood that cavities 612a, 614a of first and second barrel portions 612, 614 of extruder barrel 610 includes an internal coating. In the present disclosure, internal coating is applied along the inner surfaces of first and second barrel portions 612, 614 inside of cavities 612a, 614a; such internal coating formed inside of first and second barrel portions 612, 614 is denoted by a grey-tone shown in FIGS. 18-19. It should be understood that internal coating applied to the extruder barrel 610 may be any suitable corrosion protection and/or wear resistant inlay or coating as discussed herein.

The structural configuration of extruder barrel 610 is considered advantageous at least because operators and users of extruder barrel 610 are able to recondition, repair, and/or rebuild the existing extruder barrel 610 without completely disposing of the extruder barrel 610. As discussed above, first and second barrel portions 612, 614 are releasably engaged with one another thus allowing operators and users to separate such first and second barrel portions 612, 614 from one another for repair and reconditioning reasons. As such, when the first barrel portion 612 or second barrel portion 614 is worn or damaged due to corrosion or wear, operators of extruder barrel 610 may simply remove the worn barrel portion to which the worn barrel portion may be repaired or may be replaced by new barrel portion. Such modulatory of extruder barrel 610 will reduce the overall reconditioning and repair costs for users of these extruder barrels as well as reduction in labor time and operation time when such extruder barrel 610 needs to be reconditioned. Furthermore, the structural configuration of extruder barrel 610 is also considered advantageous at least because operators of these extruder barrels 610 will have a greater line of sight or clearance when needing to view or inspect the interior space of extruder barrel 610, including inner surfaces or internal coating. With such greater line of sight, the application of the internal coating may be easier and quicker due to the inner surfaces being easily accessible when the extruder barrel 610 is broken down and the first and second barrel portions 612, 614 are separated from one another.

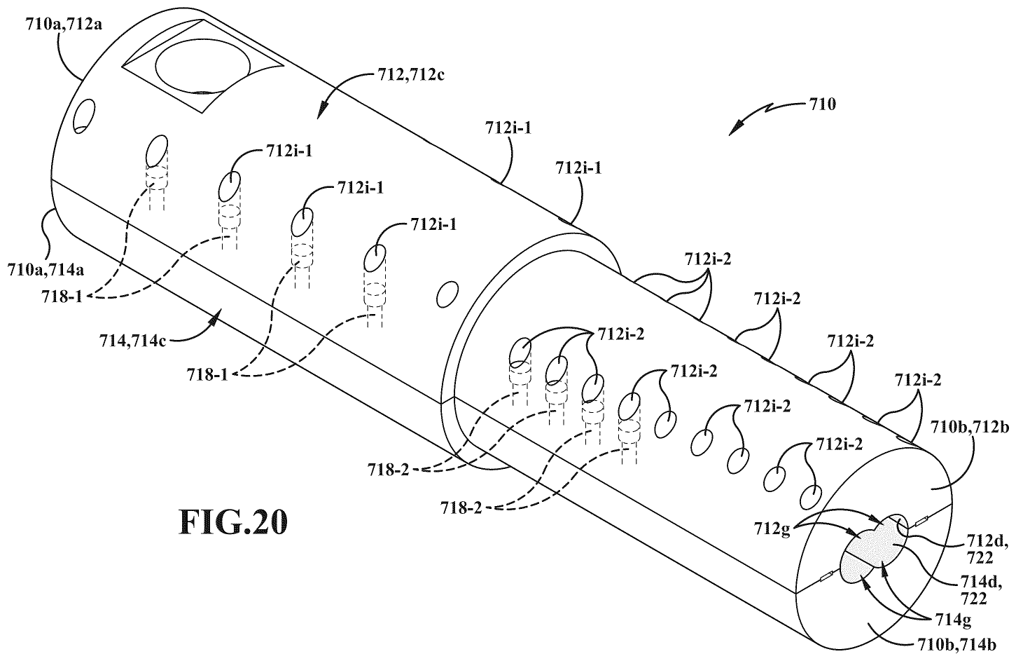

FIG. 20 illustrates yet another or eighth extruder barrel or extruder body 710. In this embodiment, extruder barrel 710 includes a first end 710a, a second end 710b that is longitudinally opposite to the first end 710a, and a longitudinal direction extending from the first end 710a to the second end 710b. Extruder barrel 710 also defines a pair of bores along a longitudinal axis of extruder barrel 710 that extends longitudinally from the first end 710a to the second end 710b that is accessible at each of the first end 710a and the second end 710b; such pair of bores of the extruder barrel 710 is discussed in greater detail below.

In the present disclosure, the extruder barrel 710 is broken into two main components, a first or upper barrel portion 712 and a second or lower barrel portion 714. As discussed in greater detail below, first barrel portion 712 and second barrel portion 714 are removably engaged with and/or removably attached with one another such that the first barrel portion 712 and the second barrel portion 714 are separable. It should be understood that the structural configuration of first barrel portion 712 and second barrel portion 714 are mirror-images of one another, relative to a longitudinal axis of extruder barrel 710, once the first barrel portion 712 and second barrel portion 714 are assembled with one another. As such, first barrel portion 712 and second barrel portion 714 are substantially similar to first barrel portion 12 and second barrel portion 14 of extruder barrel 10 discussed above, except as detailed below.

As best seen in FIG. 20, first barrel portion 712 includes a first end 712a that is positioned at the first end 710a of the extruder barrel 710, a second end 712b that is longitudinally opposite to the first end 712a and is positioned at the second end 710b of the extruder barrel 710, and a longitudinal direction extending from the first end 710a to the second end 710b. First barrel portion 712 also includes an outer surface 712c that extends longitudinally from the first end 712a to the second end 712b along the longitudinal direction of first barrel portion 712. First barrel portion 712 also includes an inner surface 712d that extends longitudinally from the first end 712a to the second end 712b along the longitudinal direction of first barrel portion 712 and is spaced apart from and faces in an opposing direction of the outer surface 712c. First barrel portion 712 also defines a first pair of cavities 712g that extends longitudinally between the first and second ends 712a, 712b of first barrel portion 712 substantially similar to pair of cavities 12g of first barrel portion 12 of extruder barrel 10.

Still referring to FIG. 20, second barrel portion 714 includes a first end 714a that is positioned at the first end 710a of the extruder barrel 710, a second end 714b that is longitudinally opposite to the first end 714a and is positioned at the second end 710b of the extruder barrel 710, and a longitudinal direction extending from the first end 710a to the second end 710b. Second barrel portion 714 also includes an outer surface 714c that extends longitudinally from the first end 714a to the second end 714b along the longitudinal direction of second barrel portion 714. Second barrel portion 714 also includes an inner surface 714d that extends longitudinally from the first end 714a to the second end 714b along the longitudinal direction of second barrel portion 714 and is spaced apart from and faces in an opposing direction of the outer surface 714c. Second barrel portion 714 also defines a first pair of cavities 714g that extends longitudinally between the first and second ends 714a, 714b of second barrel portion 712 substantially similar to pair of cavities 14g of second barrel portion 14 of extruder barrel 10.

Still referring to FIG. 20, first barrel portion 712 also defines sets of passageways 712i-1, 712i-2 similar to the set of passageways 12i defined in the first barrel portion 12 of extruder barrel 10. In this embodiment, however, a first set of passageways 712i-1 is defined in the first barrel portion 712 between the first end 712a to a medial location or position defined between the first and second end 712a, 712b. In one exemplary embodiment, a shoulder or step defined in the first barrel portion 712 is the medial location. Additionally, in this embodiment, a second set of passageways 712i-2 is defined in the first barrel portion 712 between the second end 712b to a medial location or position defined between the first and second end 712a, 712b. In one exemplary embodiment, a shoulder or step defined in the first barrel portion 712 is the medial location.

It should be noted that sets of connectors 718-1, 718-2 are also included with extrusion barrel 710 to removably engage the first barrel portion 712 and the second barrel portion 714 with one another. In FIG. 20, a first set of connectors 718-1 pass through the first set of passageways 712i-1 of the first barrel portion 712 and then threadably engages with a set of threaded passageways or holes (not illustrated) defined in the second barrel portion 714 and aligned with the first set of passageways 712i-1; as such, the first set of connectors 718-1 operates substantially similar to the connectors 18 used in extruder barrel 10 for removably engaging the first and second barrel portions 12, 14 with one another as discussed above. Additionally, a second set of connectors 718-2 pass through the second set of passageways 712i-2 of the first barrel portion 712 and then threadably engage with another set of threaded passageways or holes (not illustrated) defined in the second barrel portion 714 and aligned with the second set of passageways 712i-2 as such, the second set of connectors 718-2 operates substantially similar to the connectors 18 used in extruder barrel 10 for removably engaging the first and second barrel portions 12, 14 with one another as discussed above. It should also be noted that the number of connectors of the sets of connectors 718-1, 718-2 matches with the number of passageways of the sets of passageways 712i-1, 712i-2 defined in the first barrel portion 712 and with the number of threaded holes defined in the second barrel portion 714.

In this embodiment, the second set of passageways 712i-2 includes a greater number of passageways as compared to the number of passageways included in the first set of passageways 712i-1. Such greater number of passageways in the second set of passageways 712i-2 is considered advantageous at least because a greater amount of connectors of a set of connectors 718-2 are used to releasably engage the first barrel portion 712 and the second barrel portion 714 with one another to avoid separation of the first barrel portion 712 and the second barrel portion 714 at the discharge or dispense end (i.e., second end 710b). In operation, twin conically-shaped extrusion screws (such as the twin conically-shaped extrusion screws 40 discussed above) housed inside of the extrusion barrel 710 as well as material being linearly moved towards the second end 710b of extrusion barrel 710 may generate a greater amount of force inside of the extrusion barrel 710 towards the second or dispensing end 710b thus causing the first barrel portion 712 and the second barrel portion 714 to separate. As such, the greater number of connectors of the second set of connectors 718-2 engaged at the dispensing end of the extruder barrel 710 to provide additional rigidity and strength to prevent unwanted separation of the first barrel portion 712 and the second barrel portion 714 where the load is highest.

It should be noted that extruder barrel 710 may also include further features, elements, or components that are present in extruder barrel 10 as discussed above and as illustrated in FIGS. 1-9C.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An extruder barrel of an extrusion assembly, comprising:
a first barrel portion defining a first cavity;
a second barrel portion removably engaging with the first barrel portion and defining a second cavity;
a bore at least partially defined by the first cavity of the first barrel portion and by the second cavity of the second barrel portion;
wherein the first barrel portion and the second barrel portion are configurable between an assembled configuration and a disassembled configuration.

2. The extruder barrel of claim 1, wherein when the first barrel portion and the second barrel portion are in the disassembled configuration, line of sights of the first cavity of the first barrel portion and the second cavity of the second barrel portion are completely viewable along longitudinal axes of the first barrel portion and second barrel portion.

3. The extruder barrel of claim 1, further comprising:
a set of connectors releasably engaging the first barrel portion and the second barrel portion together at the assembled configuration.

4. The extruder barrel of claim 1, further comprising:
a first set of connectors releasably engaging the first barrel portion and the second barrel portion together at the assembled configuration between a first end of the extruder barrel and a medial point located between the first end of the extruder barrel and a second end of the extruder barrel; and
a second set of connectors releasably engaging the first barrel portion and the second barrel portion together at the assembled configuration between the second end of the extruder barrel and the medial point located between the first end of the extruder barrel and a second end of the extruder barrel;
wherein the second set of connectors is greater than the first set of connectors.

5. The extruder barrel of claim 3, further comprising:
a set of passageways defined in the first barrel portion; and
a set of threaded holes defined in the second barrel portion;
wherein a respective connector of the set of connectors passes through a respective passageway of the set of passageways and releasably engages with the second barrel portion inside a respective threaded hole of the set of threaded holes.

6. The extruder barrel of claim 3, further comprising:
a set of alignment pins that aligns and engages the first barrel portion and the second barrel portion with one another.

7. The extruder barrel of claim 6, further comprising:
a set of first alignment cavities defined in the first barrel portion; and
a set of second alignment cavities defined in the second barrel portion;
wherein a first end of each alignment pin of the set of alignment pins is received by the first barrel portion inside a respective alignment cavity of the set of first alignment cavities; and
wherein a second end of each alignment pin of the set of alignment pins is received by the second barrel portion inside a respective alignment cavity of the set of second alignment cavities.

8. The extruder barrel of claim 1, further comprising:
a pair of recesses defined between a first end of the first barrel portion and a second end of the first barrel portion.

9. The extruder barrel of claim 1, further comprising:
a first pair of recesses defined between a first end of the first barrel portion and a second end of the first barrel portion; and
a second pair of recesses defined between a first end of the second barrel portion and a second end of the second barrel portion.

10. The extruder barrel of claim 1, further comprising:
an internal coating applied to the first cavity of the first barrel portion and the second cavity of the second barrel portion.

11. The extruder barrel of claim 10, wherein when the internal coating is applied to the first cavity of the first barrel portion and the second cavity of the second barrel portion, the extruder barrel is in the disassembled configuration.

12. The extruder barrel of claim 10, wherein the internal coating is a corrosion or wear resistant coating.

13. The extruder barrel of claim 1, further comprising:
a third barrel portion defining a third cavity;
wherein the bore, collectively, is at least partially defined by the first barrel portion, the second barrel portion, and the third barrel portion.

14. The extruder barrel of claim 1, further comprising:
a third barrel portion defining a third cavity; and
a fourth barrel portion removably engaging with the third barrel portion and defining a fourth cavity;
wherein the bore, collectively, is at least partially defined by the first barrel portion, the second barrel portion, the third barrel portion, and the fourth barrel portion.

15. A method of reconditioning an extruder barrel, comprising:
loosening a set of connectors of the extruder barrel from a first barrel portion of the extruder barrel and a second barrel portion of the extruder barrel;
separating the first barrel portion from the second barrel portion;
replacing the first barrel portion with a third barrel portion;
aligning the third barrel portion with the second barrel portion by a set of alignment pins of the extruder barrel; and
securing the third barrel portion with the second barrel portion by the set of connectors.

16. The method of claim 15, wherein the step of loosening the set of connections further comprises:
disengaging the set of connectors from a set of threaded holes defined in the second barrel portion; and
removing the set of connectors from a set of passageways defined in the first barrel portion.

17. The method of claim 15, wherein the step of separating the first barrel portion from the second barrel portion further comprises:
completely viewing a first cavity defined by the first barrel portion and a second cavity of the second barrel portion that collectively define a bore of the extruder barrel.

18. The method of claim 15, wherein step of aligning the third barrel portion with the second barrel portion further comprises:
engaging the set of alignment pins with the second barrel portion inside a set of first alignment cavities; and
passing the set of alignment through the third barrel portion inside a set of second alignment cavities.

19. The method of claim 15, wherein the step of separating the first barrel portion from the second barrel portion further comprises:
disengaging a first pair of intermediate surfaces of the first barrel portion from a second pair of intermediate surfaces of the second barrel portion.

20. The method of claim 19, further comprising:
defining a first recess in the first barrel portion that separates the intermediate surfaces of the first pair of intermediate surfaces; and
defining a second recess in the second barrel portion that separates the intermediate surfaces of the second pair of intermediate surfaces;
wherein the first recess and the second recess are aligned with one another prior to the step of separating the first barrel portion from the second barrel portion.

21. The method of claim 20, wherein the step of securing the third barrel portion with the second barrel portion further comprises:
engaging a third pair of intermediate surfaces of the third barrel portion with the second pair of intermediate surfaces of the second barrel portion.

22. The method of claim 15, wherein the third barrel portion is a refurbished first barrel portion having a reconditioned internal coating.
